(19) United States
(12) Patent Application Publication
(10) Pub. No.: US 2025/0039876 A1
(43) Pub. Date: Jan. 30, 2025

(54) TERMINAL CAPABILITY INDICATION METHOD AND APPARATUS, SCHEDULING METHOD AND APPARATUS, TERMINAL, AND COMMUNICATION DEVICE

(71) Applicant: VIVO MOBILE COMMUNICATION CO., LTD., Guangdong (CN)

(72) Inventors: Siqi LIU, Guangdong (CN); Jialin LI, Guangdong (CN); Zichao JI, Guangdong (CN)

(73) Assignee: VIVO MOBILE COMMUNICATION CO., LTD., Guangdong (CN)

(21) Appl. No.: 18/914,530

(22) Filed: Oct. 14, 2024

Related U.S. Application Data
(63) Continuation of application No. PCT/CN2023/087812, filed on Apr. 12, 2023.

(30) Foreign Application Priority Data
Apr. 14, 2022 (CN) 202210414134.2

(51) Int. Cl. H04W 72/1273

(52) U.S. Cl. CPC H04W 72/1273

(57) ABSTRACT

This application discloses a terminal capability indication method and apparatus, a scheduling method and apparatus, a terminal, and a communication device. The terminal capability indication method includes: sending, by a terminal, terminal capability information to a network side device, where the terminal capability information includes a processing capability of the terminal for first control information and/or a processing capability of the terminal for second control information; and receiving, by the terminal, at least two scheduling information, where the at least two scheduling information meet a requirement corresponding to the terminal capability information, and the scheduling information is at least one of the first control information and the second control information, where the first control information corresponds to N objects, and N is greater than or equal to 1; and the second control information corresponds to M objects, and M is greater than or equal to 2.

### CROSS-REFERENCE TO RELATED APPLICATIONS

This application is a Bypass Continuation Application of PCT International Application No. PCT/CN2023/087812 filed on Apr. 12, 2023, which claims priority to Chinese Patent Application No. 202210414134.2, filed in China on Apr. 14, 2022, which is incorporated herein by reference in its entirety.

### TECHNICAL FIELD

This application pertains to the field of communication technologies, and specifically relates to a terminal capability indication method and apparatus, a scheduling method and apparatus, a terminal, and a communication device.

### BACKGROUND OF THE INVENTION

A network side device supports configuring one or more component carriers (CC) or cells for a terminal. When the terminal is configured with a single carrier mode or a self-scheduling mode in carrier aggregation (CA), the terminal monitors a physical downlink control channel (PDCCH) to receive downlink control information (DCI), and demodulates, based on an indication of the DCI, a physical downlink shared channel (PDSCH) scheduled by the network side device. The DCI may flexibly indicate resource allocation of the PDSCH, for example, a cell or a bandwidth part (BWP), a frequency domain resource, and a time domain resource of the PDSCH. In the prior art, one DCI may schedule uplink (UL) or downlink (DL) data in one cell. Therefore, a large quantity of DCI overheads may be caused in the case of CA.

### SUMMARY OF THE INVENTION

According to a first aspect, a terminal capability indication method is provided. The method is applied to a terminal and includes:
sending, by a terminal, terminal capability information to a network side device, where the terminal capability information includes a processing capability of the terminal for first control information and/or a processing capability of the terminal for second control information; and
receiving, by the terminal, at least two scheduling information, where the at least two scheduling information meet a requirement corresponding to the terminal capability information, and the scheduling information is at least one of the first control information and the second control information, where
the first control information corresponds to N objects, and N is greater than or equal to 1; and
the second control information corresponds to M objects, and M is greater than or equal to 2.

According to a second aspect, a terminal capability indication apparatus is provided. The apparatus is applied to a terminal and includes:
a first sending module, configured to send terminal capability information to a network side device, where the terminal capability information includes a processing capability of the terminal for first control information and/or a processing capability of the terminal for second control information; and
a first receiving module, configured to receive at least two scheduling information, where the at least two scheduling information meet a requirement corresponding to the terminal capability information, and the scheduling information is at least one of the first control information and the second control information, where
the first control information corresponds to N objects, and N is greater than or equal to 1; and
the second control information corresponds to M objects, and M is greater than or equal to 2.

According to a third aspect, a scheduling method is provided. The method is applied to a communication device and includes:
processing, by a communication device, control information based on a scheduling constraint, where the scheduling constraint includes a scheduling constraint on first control information and/or a scheduling constraint on second control information, where
the first control information corresponds to N objects, and N is greater than or equal to 1; and
the second control information corresponds to M objects, and M is greater than or equal to 2.

According to a fourth aspect, a scheduling apparatus is provided. The apparatus is applied to a communication device and includes:
a processing module, configured to process control information based on a scheduling constraint, where the scheduling constraint includes a scheduling constraint on first control information and/or a scheduling constraint on second control information, where
the first control information corresponds to N objects, and N is greater than or equal to 1; and
the second control information corresponds to M objects, and M is greater than or equal to 2.

According to a fifth aspect, a terminal is provided. The terminal includes a processor and a memory, the memory stores a program or an instruction that can be run on the processor, and the program or the instruction is executed by the processor to implement the steps of the method according to the first aspect.

According to a sixth aspect, a terminal is provided, including a processor and a communication interface. The communication interface is configured to: send terminal capability information to a network side device, where the terminal capability information includes a processing capability of the terminal for first control information and/or a processing capability of the terminal for second control information; and receive at least two scheduling information, where the at least two scheduling information meet a requirement corresponding to the terminal capability information, and the scheduling information is at least one of the first control information and the second control information, where
the first control information corresponds to N objects, and N is greater than or equal to 1; and
the second control information corresponds to M objects, and M is greater than or equal to 2.

According to a seventh aspect, a communication device is provided. The communication device includes a processor and a memory, the memory stores a program or an instruction that can be run on the processor, and the program or the instruction is executed by the processor to implement the steps of the method according to the third aspect.

According to an eighth aspect, a communication device is provided, including a processor and a communication interface. The processor is configured to process control information based on a scheduling constraint, where the scheduling constraint includes a scheduling constraint on first control information and/or a scheduling constraint on second control information, where
the first control information corresponds to N objects, and N is greater than or equal to 1; and
the second control information corresponds to M objects, and M is greater than or equal to 2.

According to a ninth aspect, a communication system is provided, including a terminal and a communication device. The terminal may be configured to perform the steps of the terminal capability indication method according to the first aspect, and the communication device may be configured to perform the steps of the scheduling method according to the third aspect.

According to a tenth aspect, a readable storage medium is provided. The readable storage medium stores a program or an instruction, and the program or the instruction is executed by a processor to implement the steps of the method according to the first aspect or the steps of the method according to the third aspect.

According to an eleventh aspect, a chip is provided. The chip includes a processor and a communication interface, the communication interface is coupled to the processor, and the processor is configured to run a program or an instruction to implement the method according to the first aspect or the method according to the third aspect.

According to a twelfth aspect, a computer program/program product is provided. The computer program/program product is stored in a storage medium, and the computer program/program product is executed by at least one processor to implement the steps of the terminal capability indication method according to the first aspect or the steps of the scheduling method according to the third aspect.

### BRIEF DESCRIPTION OF DRAWINGS

FIG. 1 is a block diagram of a wireless communication system to which the embodiments of this application are applicable;

FIG. 2 is a schematic flowchart of a terminal capability indication method according to an embodiment of this application;

FIG. 3 is a schematic flowchart of a scheduling method according to an embodiment of this application;

FIG. 4 is a schematic structural diagram of a terminal capability indication apparatus according to an embodiment of this application;

FIG. 5 is a schematic structural diagram of a scheduling apparatus according to an embodiment of this application;

FIG. 6 is a schematic structural diagram of a communication device according to an embodiment of this application;

FIG. 7 is a schematic structural diagram of a terminal according to an embodiment of this application; and

FIG. 8 is a schematic structural diagram of a network side device according to an embodiment of this application.

### DETAILED DESCRIPTION OF THE INVENTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTEYLTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th generation (6G) communication system.

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a radio access network (RAN), a radio access network function, or a radio access network unit. The access network device may include a base station, a wireless local area network (WLAN) access point, a wireless fidelity (Wi-Fi) node, or the like. The base station may be referred to as a NodeB, an evolved NodeB (eNB), an access point, a base transceiver station (Base Transceiver Station, BTS), a radio base station, a radio transceiver, a basic service set (BSS), an extended service set (ESS), a home NodeB, a home evolved NodeB, a transmitting receiving point (TRP), or another appropriate term in the field. As long as a same technical effect is achieved, the base station is not limited to a specified technical term. It should be noted that, in this application, only a base station in an NR system is used as an example, and a specific type of the base station is not limited.

With reference to the accompanying drawings, the following describes in detail the terminal capability indication method provided in the embodiments of this application by using some embodiments and application scenarios thereof.

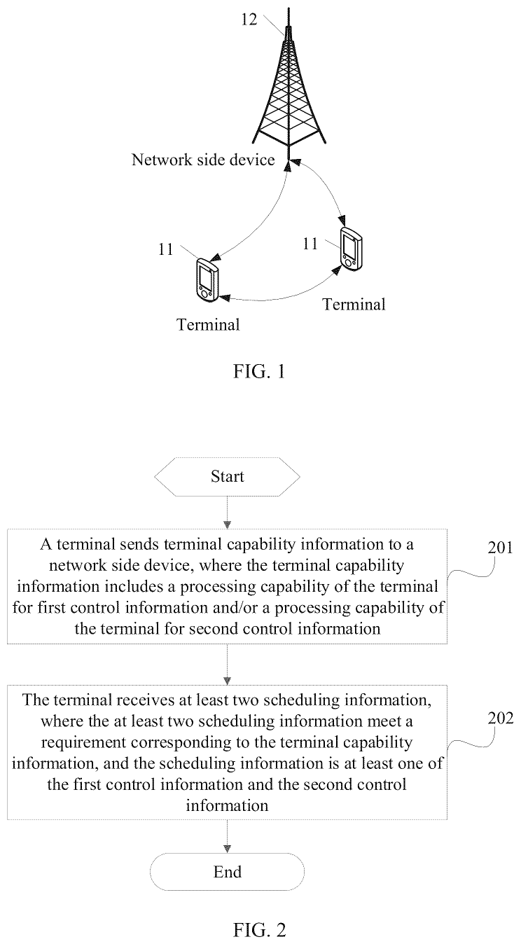

As shown in FIG. 2, an embodiment of this application provides a terminal capability indication method, including:

Step 201: A terminal sends terminal capability information to a network side device, where the terminal capability information includes a processing capability of the terminal for first control information and/or a processing capability of the terminal for second control information.

Step 202: The terminal receives at least two scheduling information, where the at least two scheduling information meet a requirement corresponding to the terminal capability information, and the scheduling information is at least one of the first control information and the second control information, where
the first control information corresponds to N objects, and N is greater than or equal to 1; and
the second control information corresponds to M objects, and M is greater than or equal to 2.

It should be noted that, in this embodiment of this application, the object may be a cell, a carrier, a bandwidth part (BWP), or the like.

The terminal capability information includes a processing capability of the terminal for control information sent by the network side device, and the processing capability may include a monitoring capability, a detection capability, a processing capability, and the like, for example, a number of control information processed by the terminal. The control information may include the first control information and/or the second control information. The first control information corresponds to N objects. For example, the first control information is used to schedule/indicate/activate/deactivate the N objects. The second control information corresponds to M objects. For example, the second control information is used to schedule/indicate/activate/deactivate the M objects. Optionally, the first control information may be used to schedule data transmission of the N objects, and the second control information may be used to schedule data transmission of the M objects. That is, this embodiment of this application defines a capability of the terminal to process control information for scheduling data transmission of one and/or more objects.

The terminal capability information may indicate that the terminal supports processing (including scheduling/indication/activation/deactivation) of control information related to multiple objects and the control information related to multiple objects may be represented as control information corresponding to multiple objects (mc-control). When the terminal indicates that the terminal supports mc-control or the network side device is configured with mc-control or the network side device activates mc-control or mc-control is transmitted (sent/received), the terminal may determine processing behavior of the first control information and/or the second control information based on the terminal capability information.

The first control information corresponds to one or more objects, and the second control information corresponds to two or more objects. In this case, the first control information may include the second control information. When the first control information schedules two or more objects, the first control information is the second control information, or may be expressed as “mc-control”. When the first control information schedules data transmission of one object, the first control information may be control information corresponding to a single object (sc-control).

The control information in this embodiment of this application may be at least one of the following information: DCI, a DCI format, a PDCCH, a candidate PDCCH (PDCCH candidate), a control channel element (CCE), and the like. There may be a plurality of DCI formats, and these DCI formats are all DCI.

The first control information may be DCI, unicast DCI, dedicated DCI, or DCI in a connected state.

The network side device may determine a scheduling constraint on the terminal based on the terminal capability information, and the network side device schedules the terminal based on the scheduling constraint. The scheduling constraint such as a number of control information sent by the network side device to the terminal needs to meet a terminal capability of the terminal. The terminal may determine the scheduling constraint based on the terminal capability information, and the terminal transmits control information based on the scheduling constraint. For example, the scheduling constraint restricts a number of control information processed by the terminal.

When the terminal receives scheduling information sent by the network side device, the scheduling information meets a requirement corresponding to the terminal capability information. For example, if the scheduling information is the first control information, and the terminal capability information restricts a number of first control information processed within given duration to A, a number of first control information received by the terminal within a first duration does not exceed A.

Optionally, in the scheduling information received by the terminal, a receiving time interval between adjacent scheduling information meets the requirement corresponding to the terminal capability information.

In this embodiment of this application, a capability of a terminal to process control information of different objects is defined. The terminal reports information about the terminal capability to a network side device, so that a scheduling constraint of the network side device during scheduling on the terminal meets the terminal capability. This avoids a problem of excessive UE complexity due to too much control information that needs processed by the terminal, and can also avoid a problem that information transmission fails due to discarding or missing detection of the control information.

Optionally, the M objects include an object in which the second control information is located, that is, a scheduling object. If target control information in the first control information corresponds to M objects, the M objects include an object in which the target control information is located.

Optionally, the processing capability of the terminal for the first control information includes at least one of the following:

1) A capability of processing first control information within a first duration.

The first duration may be given duration, and may be set or defined based on the terminal capability. The capability of processing the first control information may be a processing number of first control information, and the terminal capability information restricts a number (for example, K1) of first control information detected/monitored/processed within a given time period. The first duration may be one of the following: X consecutive slots, monitoring occasions, spans, symbols, duration, or periodicities.

Optionally, the first duration may be at least one of the following: X consecutive slots, monitoring occasions, spans, symbols, duration, or periodicities of scheduling cell subcarrier spacings (SCS).

When the scheduling information is the first control information, if the terminal capability information restricts the number of first control information processed within the first duration to K1, a number of first control information received by the terminal within the first duration does not exceed K1.

2) A capability of processing first control information related to a first SCS.

The capability of processing the first control information may be a processing number of first control information, and the first SCS is, for example, an SCS 1. That is, the terminal capability information restricts a number (for example, K2) of first control information processed by the terminal for an SCS.

Optionally, the first SCS may be:

a: An SCS of a scheduling object (for example, a scheduling cell).

b: An SCS of a scheduled object (for example, a scheduled cell).

c: A maximum/minimum SCS in SCSs of scheduled objects (for example, scheduled cells).

d: A maximum/minimum SCS in an SCS of a scheduling object (for example, a scheduling cell) and an SCS of a scheduled object (for example, a scheduled cell).

e. A preset SCS of a scheduled cell.

f. A preset SCS of a scheduling cell.

g: A schedulable SCS.

Optionally, the first SCS is a schedulable SCS. This embodiment is applied to that N of the first control information is not fixed or mc-control fixedly schedules N objects but the N objects are not fixed. For example, if one mc-control schedules two cells (15/30 k) and another mc-control schedules three cells (15/30/60 k), the schedulable SCS may be an SCS in 15/30/60.

h: A maximum/minimum/preset SCS in schedulable SCSs.

Optionally, the first SCS is a maximum/minimum/preset SCS in schedulable SCSs. This embodiment is applied to that N of the first control information is not fixed or mc-control fixedly schedules N objects but the N objects are not fixed. For example, if one mc-control schedules two cells (15/30 k) and another mc-control schedules three cells (15/30/60 k), the first SCS may be a maximum/minimum/preset SCS in 15/30/60.

i: An SCS that can be used for a scheduling object.

j. A maximum/minimum/preset SCS in SCSs that can be used for scheduling objects.

k: A maximum/minimum/preset SCS in an object group (Cell group).

Optionally, in an example in which the object is a cell, the cell group may be cells in a same cell group, cells in a same timing advance group (TAG), cells corresponding to a same PUCCH cell (also referred to as a same PUCCH group), or cell corresponding to same timing (for example, cells configured with no ca-SlotOffset or cells configured with same ca-SlotOffset).

Optionally, the first SCS is a maximum/minimum/preset SCS in a cell group. This embodiment is applied to that N of the first control information is not fixed or mc-control fixedly schedules N objects but the N objects are not fixed. For example, if one mc-control schedules two cells (15/30 k) and another mc-control schedules three cells (15/30/60 k), the first SCS may be an SCS in (15/30 k) or an SCS in (15/30/60 k).

l: An SCS that can be used. The SCS that can be used may be a supported SCS or a configurable SCS.

m: A maximum/minimum/preset SCS in SCSs that can be used, for example, a maximum/minimum/specific SCS in supported SCSs or configurable SCSs.

For example, when the scheduling information is the first control information, and the first control information is the control information related to the first SCS, if the terminal capability information restricts the processing number of first control information related to the first SCS to K2, a number of first control information received by the terminal for the first SCS does not exceed K2.

3) A capability of processing first control information related to a first SCS pair.

The capability of processing the first control information may be a processing number of first control information. That is, the terminal capability information defines a processing number (for example, K3) of first control information for an SCS pair. The first SCS pair includes an SCS of a scheduling object and an SCS of a scheduled object, and the first SCS pair is, for example, {SCS 2, SCS 3}. Optionally, {SCS 2, SCS 3} is, for example, one of the following:
{SCS 2, SCS 3} is {SCS of scheduling cell, SCS of scheduled cell};
{SCS 2, SCS 3} is {maximum SCS in SCS of scheduling cell, SCS of scheduled cell}; and
{SCS 2, SCS 3} is {minimum SCS in SCS of scheduling cell, SCS of scheduled cell}.

4) A capability of processing first control information related to a first SCS combination.

The capability of processing the first control information may be a processing number of first control information. That is, the terminal capability information defines a processing number (for example, K4) of first control information for an SCS combination. The first SCS combination may be a combination of an SCS of a scheduling object and an SCS of a scheduled object. The first SCS combination is, for example, {SCS 0, SCS i}, where the SCS 0 is an SCS of a scheduling object, and the SCS i is an SCS of a scheduled object, and may be a maximum/minimum/specific SCS in SCSs of scheduled objects.

5) A capability of processing first control information related to a quantity of scheduled objects.

The capability of processing the first control information may be a processing number of first control information. That is, the terminal capability information defines a processing number (for example, K5) of first control information for a quantity of scheduled objects. For example, one mc-control schedules data transmission of two cells, and another mc-control schedules data transmission of three cells. The terminal capability information may separately define a processing capability of mc-control for scheduling two cells and a processing capability of mc-control for scheduling three cells.

6) A capability of processing first control information related to a total quantity of scheduling object and scheduled object.

The capability of processing the first control information may be a processing number of first control information. That is, the terminal capability information defines a processing number (for example, K6) of first control information for a total quantity of scheduling object and scheduled object. For example, if one mc-control schedules data transmission of two cells, a total quantity of scheduling cell and scheduled cell is 3; and if another mc-control schedules data transmission of three cells, a total quantity of scheduling cell and scheduled cell is 4. The terminal capability information may separately define a processing capability of mc-control for a total quantity 3 of scheduling cells and scheduled cells and a processing capability of mc-control for a total quantity 4 of scheduling cells and scheduled cells.

7) A capability of processing first control information related to a relationship between an SCS of a scheduling object and an SCS of a scheduled object.

The capability of processing the first control information may be a processing number of first control information. That is, the terminal capability information defines a processing number (for example, K7) of first control information for a relationship between an SCS of a scheduling object and an SCS of a scheduled object.

Optionally, in an example in which the object is a cell, the relationship between the SCS of the scheduling object and the SCS of the scheduled object is one of the following:
the relationship between the SCSs is: an SCS of a scheduling cell>an SCS of a scheduled cell;
the relationship between the SCSs is: an SCS of a scheduling cell=an SCS of a scheduled cell;
the relationship between the SCSs is: an SCS of a scheduling cell<an SCS of a scheduled cell;
the relationship between the SCSs is: an SCS of a scheduling cell is different from an SCS of a scheduled cell, that is, crossCarrierScheduling-DiffSCS;
the relationship between the SCSs is: an SCS of a scheduling cell is the same as an SCS of a scheduled cell, that is, crossCarrierScheduling-SameSCS, where for example, in this embodiment of this application, all scheduled objects and scheduling objects corresponding to mc-control correspond to crossCarrierScheduling-SameSCS; and
the relationship between the SCSs is: a ratio of an SCS of a scheduling cell to an SCS of a scheduled cell is L.

Optionally, L=a ratio of an SCS of a scheduling object to an SCS of a scheduled object; or L=a ratio of an SCS of a scheduled object to an SCS of a scheduling object. Then SCS of a scheduled object may be: all SCSs of scheduled objects/a part of SCSs of scheduled objects/a maximum SCS of a scheduled object/a minimum SCS of a scheduled object.

8) A capability of processing first control information related to a first scheduling object.

The capability of processing the first control information may be a processing number of first control information. That is, the terminal capability information restricts a processing number (for example, K8) of first control information for a scheduling object.

It should be noted that the first scheduling object may be a scheduling object or each scheduling object.

9) A capability of processing first control information related to a first scheduled object.

The capability of processing the first control information may be a processing number of first control information. That is, the terminal capability information restricts a processing number (for example, K9) of first control information for a scheduled object.

It should be noted that the first scheduled object may be a scheduled object or each scheduled object.

10) A capability of processing first control information for time division multiplexing (TDD).

The capability of processing the first control information may be a processing number of first control information. That is, the terminal capability information restricts a processing number (for example, K10) of first control information for TDD.

Optionally, TDD-specific may be understood as a scheduling object in TDD. That is, the terminal capability information restricts a processing number of first control information for a scheduling object in TDD.

11) A capability of processing first control information for frequency division duplex (FDD).

The capability of processing the first control information may be a processing number of first control information. That is, the terminal capability information restricts a processing number (for example, K11) of first control information for FDD.

Optionally, FDD-specific may be understood as a scheduling object in FDD. That is, the terminal capability information restricts a processing number of first control information for a scheduling object in FDD.

12) A capability of processing first control information for a first frequency domain.

The first frequency domain is, for example, an FR 1 or a licensed band or a frequency domain in which a shared access technology does not exist. The capability of processing the first control information for the first frequency domain is, for example, a capability of processing corresponding first control information when a scheduling object and/or a scheduled object are/is in the FR 1 or the licensed band, and the processing capability may be a processing number of first control information.

13) A capability of processing first control information for a second frequency domain.

The second frequency domain is, for example, an FR 2 or an FR 3 or an unlicensed band or a frequency domain in which a shared access technology exists. The capability of processing the first control information for the second frequency domain is, for example, a capability of processing corresponding first control information when a scheduling object and/or a scheduled object are/is in the FR 2 or the FR 3 or the unlicensed band, and the processing capability may be a processing number of first control information.

14) A first monitoring capability.

The first monitoring capability is, for example, a slot-level monitoring capability, a monitoring capability corresponding to r15monitoringcapability, or a corresponding monitoring capability when r15monitoringcapability is not configured.

Optionally, in this embodiment of this application, all scheduled objects corresponding to mc-control correspond to a same monitoring capability, for example, all correspond to the first monitoring capability.

Optionally, in this embodiment of this application, all scheduled objects and scheduling objects corresponding to mc-control correspond to a same monitoring capability, for example, all correspond to the first monitoring capability.

15) A second monitoring capability.

The second monitoring capability is, for example, a span-level monitoring capability or a monitoring capability corresponding to r16monitoringcapability.

(16) A capability of processing first control information related to a relationship between SCSs of scheduled objects.

Optionally, the relationship between the SCSs of the scheduled objects may be:
at least two (preferably, all) SCSs of scheduled objects are different; or
at least two (preferably, all) SCSs of scheduled objects are the same.

Optionally, in this embodiment of this application, if the first control information actually schedules only one object, the first control information may be considered as sc-control, for example, unicast DCI. If the first control information includes mc-control, it may be explained that mc-control is also unicast DCI.

It should be noted that a plurality of cases of the processing capability of the terminal for the first control information may simultaneously exist. When the plurality of cases of the processing capability simultaneously exist, numbers of corresponding first control information may be separately restricted for different processing capabilities, or a total number of first control information may be restricted for a plurality of processing capabilities. When the processing capability represents a number of first control information processed by the terminal, values of K1 to K11 may be the same or different. The following uses examples to describe meanings of the foregoing processing capabilities when they simultaneously exist.

Examples 1: when 1) and 2) simultaneously exist, there may be the following two meanings:

(1): The terminal capability restricts a number of first control information detected/monitored/processed within a first duration based on SCS=SCS 1 to K. In this case, a total number of first control information processed when both 1) and 2) simultaneously exist is restricted. In this case, it may be understood that K1=K2=K.

(2): The terminal capability restricts a number of first control information detected/monitored/processed within a first duration to K1, where a processing number of first control information for SCS=SCS 1 is K2. In this case, processing numbers of first control information corresponding to 1) and 2) are separately restricted, that is, K1 and K2 need to be simultaneously supported in this case.

Example 2: When the foregoing 1), 2), 9), and 10) simultaneously exist, it may be understood that:

The terminal capability restricts a number of first control information processed within a first duration based on SCS=SCS 1 (for example, SCS 1=SCS of a scheduling CC) per scheduled cell for a scheduling cell in TDD to K (K unicast DCI scheduling DL or UL per scheduling CC slot per scheduled CC for TDD scheduling CC). In this case, a total number of first control information processed when 1), 2), 9), and 10) simultaneously exist is restricted. Optionally, processing numbers of first control information corresponding to 1), 2), 9), and 10) may be separately restricted, that is, K1, K2, K9, and K10 need to be simultaneously supported in this case.

Example 3: When the foregoing 1), 2), 9), and 11) simultaneously exist, it may be understood that:

The terminal capability restricts a number of first control information processed within a first duration based on SCS=SCS 1 (for example, SCS 1=SCS of a scheduling CC) per scheduled cell for a scheduling cell in FDD to K (K unicast DCI scheduling DL or UL per scheduling CC slot per scheduled CC for FDD scheduling CC). In this case, a total number of first control information processed when 1), 2), 9), and 11) simultaneously exist is restricted. Optionally, processing numbers of first control information corresponding to 1), 2), 9), and 11) may be separately restricted, that is, K1, K2, K9, and K11 need to be simultaneously supported in this case.

Example 4: When the foregoing 1), 2), 3), 9), and 11) simultaneously exist, it may be understood that:

The terminal capability restricts a number of first control information processed within a first duration (for example, N consecutive scheduling cell slots) based on SCS=SCS 1 (for example, SCS 1=SCS of a scheduling CC) per scheduled cell for a scheduling cell in FDD to K (K unicast DCI scheduling DL or UL per N consecutive scheduling CC slot per scheduled CC for FDD scheduling CC). In this case, a total number of first control information processed when 1), 2), 3), 9), and 11) simultaneously exist is restricted. Optionally, it may be understood that processing numbers of first control information corresponding to 1), 2), 3), 9), and 11) are separately restricted, that is, K1, K2, K3, K9, and K11 need to be simultaneously supported in this case.

N is based on an SCS pair (SCS of scheduling CC, SCS of scheduled CC). For example, N=2 for (30, 15), (60, 30), (120, 60); N=4 for (60, 5) and (120, 30); and N=8 for (120, 15).

Example 5: When the foregoing 1), 2), 3), 9), and 10) simultaneously exist, it may be understood that:

The terminal capability restricts a number of first control information processed within a first duration (for example, N consecutive scheduling cell slots) based on SCS=SCS 1 (for example, SCS 1=SCS of a scheduling CC) per scheduled cell for a scheduling cell in TDD to K (K unicast DCI scheduling DL or UL per N consecutive scheduling CC slot per scheduled CC for TDD scheduling CC). In this case, a total number of first control information processed when 1), 2), 3), 9), and 10) simultaneously exist is restricted. Optionally, it may be understood that processing numbers of first control information corresponding to 1), 2), 3), 9), and 10) are separately restricted, that is, K1, K2, K3, K9, and K10 need to be simultaneously supported in this case.

N is based on an SCS pair (SCS of scheduling CC, SCS of scheduled CC). For example, N=2 for (30, 15), (60, 30), and (120, 60); N=4 for (60, 5) and (120, 30); and N=8 for (120, 15).

Example 6: When the foregoing 3) and 9) simultaneously exist, it may be understood that:

The terminal capability restricts a number of first control information processed for an SCS pair within a first duration based on SCS=SCS 1 (for example, SCS 1=SCS of a scheduling CC) (up to K unicast DCI scheduling for UL or DL per scheduled CC). In this case, a total number of first control information processed when 3) and 9) simultaneously exist is restricted. Optionally, it may be understood that processing numbers of first control information corresponding to 3) and 9) are separately restricted, that is, K3 and K9 need to be simultaneously supported in this case.

K is based on an SCS pair (SCS of scheduling CC, SCS of scheduled CC). For example, K=(1, 2, 4) for (15, 120), (15, 60), and (30, 120) kHz SCS; and K=(2) for (15, 30), (30, 60), and (60, 120) kHz SCS, and K is applicable to each slot of a scheduling CC.

Optionally, the capability of processing the first control information includes a number of first control information.

In this embodiment, the first control information corresponds to one or more objects. In an example in which the first control information is used to schedule a plurality of cells, when the first control information is used to schedule data transmission of the plurality of cells, the terminal may have different processing capabilities for control information used to schedule one cell and control information used to schedule a plurality of cells when determining processing behavior of the first control information. If the target control information in the first control information is used to schedule M cells, the target control information is equivalent to the second control information. Optionally, when the capability of processing the first control information is a processing number of first control information, the capability of processing the first control information may be a maximum number or a minimum number of first control information processed.

Optionally, if the capability of processing the first control information is related to target control information, and the target control information corresponds to M objects,

(1) One target control information corresponds to A first control information, where A is greater than or equal to 1.

In an example in which A is 1, that is, when a number of first control information processed by the terminal is being determined, one target control information is considered as one first control information. For example, if the terminal capability information restricts the number of first control information processed by the terminal to 4, and the terminal receives four mc-DCI (assumed to be used for scheduling four objects) sent by the network side device, the terminal processes the four mc-DCI, that is, processes four first control information, and a capability upper limit of the terminal is reached. In this case, mc-DCI belongs to unicast DCI (unicast DCI) of a scheduling object.

In an example in which A is 2, that is, when a number of first control information processed by the terminal is being determined, one target control information is considered as two first control information. For example, if the terminal capability information restricts the number of first control information processed by the terminal to 4, and the terminal receives two mc-DCI (assumed to be used for scheduling four objects) sent by the network side device, the terminal processes the two mc-DCI, that is, processes four first control information, and a capability upper limit of the terminal is reached. Preferably, in this embodiment, A is 1.

Alternatively, (2) For each scheduled object, one target control information corresponds to one first control information.

In this embodiment, when a number of first control information processed by the terminal is being determined, for each scheduled object/transmission, one target control information is considered as one first control information. In example in which the target control information is mc-DCI, the mc-DCI belongs to unicast DCI of a scheduled object.

Alternatively, (3) One target control information corresponds to M first control information.

When the target control information is used to schedule M objects, the target control information is equivalent to the second control information. When a number of first control information processed by the terminal is being determined, one target control information is considered as M first control information. In example in which M is 4, for example, if the terminal capability information restricts the number of first control information processed by the terminal to 4, and if the terminal receives one mc-DCI (assumed to be used for scheduling four objects) sent by the network side device, the terminal processes the one mc-DCI, that is, processes four first control information, and a capability upper limit of the terminal is reached.

It should be noted that, the foregoing (1) to (3) are for conversion between a processing number of target control information and a processing number of first control information in a case that the capability of processing the first control information is related to the target control information. For example, if A is 1 and one target control information corresponds to one the first control information, processing one target control information is equivalent to processing A first control information. For each scheduled object, if one target control information corresponds to one first control information, for each scheduled cell, processing one target control information is processing one first control information.

Optionally, for a first feature, one target control information corresponds to A first control information, where the first feature includes at least one of the following:

a: B time units, where B is greater than or equal to 1.

The target control information corresponds to first control information of M objects, and the time unit is, for example, a scheduling cell slot/monitoring occasion/span/symbol/duration/periodicity. In an example in which the target control information is “mc-control”, one mc-control is considered as one first control information for B scheduling cell slots/monitoring occasions/spans/symbols/duration/periodicities.

b: An SCS of a scheduling object.

In an example in which the target control information is “mc-control”, one mc-control is considered as one first control information for an SCS of a scheduling cell.

c: An SCS of a scheduling object and an SCS of a scheduled object.

In an example in which the target control information is “mc-control”, a scheduling object is a scheduling cell, and a scheduled object is a scheduled cell, one mc-control is considered as one first control information for a pair of an SCS of a scheduling cell and an SCS of a scheduled cell. The SCS of the scheduled cell may be a maximum SCS of the scheduled cell, a minimum SCS of the scheduled cell, or a specific SCS of the scheduled cell. For example, the SCS of the scheduling cell and the SCS of the scheduled cell are:
{SCS of scheduling cell, max SCS of scheduled cell};
{SCS of scheduling cell, min SCS of scheduled cell}; or
{SCS of scheduling cell, specific SCS of scheduled cell}.

d: A relationship between an SCS of a scheduling object and an SCS of a scheduled object.

In an example in which the target control information is “mc-control”, one mc-control is considered as one first control information for a relationship between an SCS of a scheduling object and an SCS of a scheduled object.

For example, the relationship between the SCS of the scheduling object and the SCS of the scheduled object is:
an SCS of a scheduling cell>an SCS of a scheduled cell;
an SCS of a scheduling cell=an SCS of a scheduled cell;
an SCS of a scheduling cell<an SCS of a scheduled cell;
an SCS of a scheduling cell and an SCS of a scheduled cell are different;
an SCS of a scheduling cell and an SCS of a scheduled cell are the same; or
a ratio of an SCS of a scheduling cell to an SCS of a scheduled cell is L.

Optionally, L=a ratio of an SCS of a scheduling object to an SCS of a scheduled object; or L=a ratio of an SCS of a scheduled object to an SCS of a scheduling object.

e: A scheduling object.

In an example in which the target control information is “mc-control”, one mc-control is considered as one first control information for a scheduling object.

The scheduling object may be a scheduling object in TDD or a scheduling object in FDD.

f: A scheduled object.

In an example in which the target control information is “mc-control”, one mc-control is considered as one first control information for a scheduled object.

The scheduled object is, for example, a scheduled object whose frequency domain location is the highest/lowest, a scheduled object whose object ID is maximum/minimum/a preset value, or a scheduled object in which the earliest/latest scheduled transmission is located.

In an example in which the scheduled object is a scheduled cell, it is assumed that there are no more than two control information for the scheduled cell, mc-DCI 1 schedules a cell 1/2/3 and mc-DCI 2 schedules a cell 2/3/4, and mc-DCI 1 and mc-DCI 2 are located in a same monitoring occasion. In this case, two DCI are received for the scheduled cell 1.

Optionally, in an example in which the object is a cell, in this embodiment of this application, the M cells include a cell in which control information corresponding to the M cells is located, that is, a scheduling cell.

Optionally, for a second feature, one target control information corresponds to one first control information for each scheduled object; and/or for a second feature, one target control information corresponds to M first control information, where
the second feature includes at least one of the following:

i: C time units, where C is greater than or equal to 1.

The target control information is first control information corresponding to M objects, and the time unit is, for example, a scheduling cell slot/monitoring occasion/span/symbol/duration/periodicity. In an example in which the target control information is “mc-control”, one mc-control is considered as M first control information for one or more scheduling cells slots/monitoring occasions/spans/symbols/duration/periodicities.

ii: An SCS of a scheduling object.

In an example in which the target control information is “mc-control”, one mc-control is considered as M first control information for an SCS of a scheduling object.

iii: A relationship between an SCS of a scheduling object and an SCS of a scheduled object.

In an example in which the target control information is “mc-control”, one mc-control is considered as M first control information for a relationship between an SCS of a scheduling object and an SCS of a scheduled object.

For example, the relationship between the SCS of the scheduling object and the SCS of the scheduled object is:
an SCS of a scheduling cell>an SCS of a scheduled cell;
an SCS of a scheduling cell=an SCS of a scheduled cell;
an SCS of a scheduling cell<an SCS of a scheduled cell;
an SCS of a scheduling cell and an SCS of a scheduled cell are different;
an SCS of a scheduling cell and an SCS of a scheduled cell are the same; or
a ratio of an SCS of a scheduling cell to an SCS of a scheduled cell is L.

Optionally, L=a ratio of an SCS of a scheduling object to an SCS of a scheduled object; or L=a ratio of an SCS of a scheduled object to an SCS of a scheduling object.

iv: A scheduling object.

In an example in which the target control information is “mc-control” and the object is a cell, one mc-control is considered as M first control information for a scheduling cell. Optionally, the scheduling cell may be a scheduling cell in TDD or a scheduling cell in FDD.

In an optional embodiment, in a case that the terminal capability information includes the processing capability of the terminal for the second control information, the terminal capability information further includes at least one of the following:
(1) a processing capability for third control information;
(2) a joint processing capability for the second control information and the first control information; and
(3) a joint processing capability for the second control information and the third control information, where
the third control information corresponds to one object.

In this embodiment, the terminal capability information may be a processing capability only for/considering the second control information (which may be expressed as mc-control); or may be a processing capability only for/considering the second control information (mc-control) and a processing capability for/considering any one or more of the foregoing (1) to (3).

In this embodiment, a capability of control information corresponding to a plurality of objects (in an example in which mc-control is mc-DCI) may be defined in two manners:

Manner 1: mc-DCI belongs to unicast DCI. The terminal capability may be jointly defined for mc-DCI and sc-DCI (that is, DCI for scheduling one object). For example, a defined processing capability of the terminal for control information includes a joint processing capability for mc-DCI and sc-DCI.

In an example in which the control information is mc-DCI, mc-DCI belongs to existing unicast DCI. In this case, a processing capability for mc-DCI is the same as the foregoing processing capability for the first control information, that is, processing numbers K1′ to K11′ of mc-DCI may separately correspond to K1 to K11 in the processing numbers of first control information.

Manner 2: mc-DCI does not belong to unicast DCI. When the terminal capability is being defined, a processing capability for mc-DCI is additionally defined. For example, when the terminal capability is being defined, only a processing capability for mc-DCI may be included, or a processing capability for mc-DCI and a processing capability for sc-DCI may be included; or a processing capability for mc-DCI and a joint processing capability for mc-DCI and sc-DCI may be included.

In an example in which the control information is mc-DCI, mc-DCI does not belong to existing unicast DCI. A UE capability for mc-DCI is additionally defined. In this case, processing numbers K1′ to K11′ of mc-DCI and processing numbers K1 to K11 of first control information are separately defined.

In an example in which the second control information is mc-control and the third control information is sc-control:

For example, the terminal capability information may include:

a: A capability only for/considering mc-control, that is, a processing capability of the terminal for second control information.

b: A capability only for/considering mc-control and a capability only for/considering sc-control (for example, unicast DCI) (this is applicable to manner 2 in this case, and mc-control and sc-control are separately considered), for example, a processing capability only for/considering mc-control and a processing capability only for/considering unicast DCI (which may be the processing capability of the terminal for the third control information).

c: A capability only for/considering mc-control and a joint processing capability for/considering mc-control and sc-control (for example, unicast DCI) (this is applicable to manner 1 or manner 2 in this case).

In this embodiment, when the terminal capability is being defined, the processing capability for the second control information may be separately defined, and the processing capability for the third control information and/or the first control information may be defined based on the separate definition of the processing capability for the second control information, where the joint processing capability for the second control information and the first control information may be defined, and/or the joint processing capability for the second control information and the third control information may be defined.

Optionally, in this embodiment of this application, one scheduled object can only be scheduled by sc-control or mc-control, and this is applicable to manner 2 in this case; or one scheduled object may be scheduled by sc-control and mc-control, and this is applicable to manner 1 in this case.

Optionally, the processing capability of the terminal for the second control information includes at least one of the following:

1) A capability of processing second control information within second duration.

The second duration may be set or defined based on the capability of the terminal. The capability of processing the second control information may be a processing number of second control information, and the terminal capability information restricts a number (for example, K1′) of second control information detected/monitored/processed within a given time period. The second duration may be one of the following: X consecutive slots, monitoring occasions, spans, symbols, duration, or periodicities.

Optionally, the second duration may be X consecutive slots/monitoring occasions/spans/symbols/duration/periodicities of SCSs of scheduling cells.

For example, if the scheduling information is the second control information, and the terminal capability information restricts the number of second control information processed by the terminal within the second duration to K1′, a number of second control information received by the terminal within the second duration does not exceed K1′.

2) A capability of processing second control information related to a second SCS.

The capability of processing the second control information may be a processing number of second control information, and the second SCS is, for example, an SCS 1. That is, the terminal capability information restricts a number (for example, K2′) of second control information processed by the terminal for an SCS.

Optionally, the second SCS includes at least one of the following:

a: An SCS of a scheduling object.

b. An SCS of a scheduled object. Optionally, the SCS of the scheduled object may be a maximum SCS in SCSs of scheduled objects, or a minimum SCS in SCSs of scheduled objects.

c: A maximum SCS in an SCS of a scheduling object and an SCS of a scheduled object.

d. An SCS of a scheduling object and a smallest SCS in the SCS of the scheduled object.

e: A target SCS of a scheduling object, where the target SCS of the scheduling object may be a preset SCS of a scheduling cell.

f. A target SCS of a scheduled object, where the target SCS of the scheduled object may be a preset SCS of a scheduled cell.

g: A schedulable SCS.

Optionally, the second SCS is a schedulable SCS. This embodiment is applied to that M of the second control information is fixed or mc-control fixedly schedules M objects but the M objects are not fixed. For example, if one mc-control schedules two objects (15/30 k) and another mc-control schedules three objects (15/30/60 k), the schedulable SCS may be an SCS in 15/30/60.

h: A first target SCS in schedulable SCSs.

Optionally, the first target SCS may be a maximum/minimum/specific SCS in the schedulable SCSs. This embodiment may be applied to that M of the second control information is not fixed or mc-control fixedly schedules M objects but the M objects are not fixed. For example, one mc-control schedules two objects (15/30 k), and another mc-control schedules three objects (15/30/60 k), the first target SCS may be a maximum/minimum/preset SCS in 15/30/60.

i. An SCS that can be used for a scheduling object.

j. A second target SCS in SCSs that can be used for scheduling objects, where the target SCS may be a maximum/minimum/specific SCS in the SCSs that can be used for scheduling objects.

k: An SCS that can be used, where the SCS that can be used may be a supported SCS or a configurable SCS.

l: A third target SCS in SCSs that can be used, where the third target SCS may be a maximum/minimum/preset SCS in the SCSs that can be used.

m: A fourth target SCS in an object group, where the fourth target SCS may be a maximum/minimum/preset SCS in the object group.

Optionally, the object group may be a cell group, and the cell group may be cells in a same cell group, cells in a same TAG, or cells corresponding to a same PUCCH cell (also referred to as a same PUCCH group). The object group may also be a CC group, a BWP group, or the like.

Optionally, the first SCS is a maximum/minimum/preset SCS in the object group. In an example in which the object group is a cell group, this embodiment may be applied to that N of the first control information is not fixed or mc-control fixedly schedules N cells but the N cells are not fixed. For example, one mc-control schedules two cells (15/30 k) and another mc-control schedules three cells (15/30/60 k), the first SCS may be an SCS in (15/30 k) or an SCS in (15/30/60 k).

For example, when the scheduling information is the second control information, and the scheduling information is the second control information related to the second SCS, if the terminal capability information restricts the processing number of second control information related to the second SCS to K2′, a number of second control information related to the second SCS and received by the terminal does not exceed K1′.

3) A capability of processing second control information related to a second SCS pair.

The capability of processing the second control information may be a processing number of second control information. That is, the terminal capability information defines a processing number (for example, K3′) of second control information for an SCS pair. The second SCS pair includes an SCS of a scheduling object and an SCS of a scheduled object, and the second SCS pair is, for example, {SCS 2, SCS 3}. Optionally, {SCS 2, SCS 3} is, for example, one of the following:
{SCS 2, SCS 3} is {SCS of scheduling cell, SCS of scheduled cell};
{SCS 2, SCS 3} is {maximum SCS in SCS of scheduling cell, SCS of scheduled cell}; and
{SCS 2, SCS 3} is {minimum SCS in SCS of scheduling cell, SCS of scheduled cell}.

4) A capability of processing second control information related to an SCS combination of a scheduled object.

The terminal capability information restricts a processing number (for example, K4′) of second control information for a scheduled SCS combination ({SCS 1, SCS 2 . . . , SCS m}). The SCS 1 may be understood as at least one of the following: an SCS whose object ID is minimum, an SCS whose object ID is maximum, a leftmost SCS, a rightmost SCS, an SCS of the first scheded object, and an SCS of the last scheduled object, that are scheduled by the second control information; and so on for other SCSs in the combination.

Further, if a same SCS exists in the SCS combination, de-replication processing needs to be performed. That is, for different SCS values in the combination, the SCS whose corresponding object ID is minimum, the SCS whose object ID is maximum, the leftmost SCS, the rightmost SCS, the SCS of the first scheduling object, or the SCS of the last scheduling object is determined as the SCS 1.

5) A capability of processing second control information related to a second SCS combination.

The capability of processing the second control information may be a processing number of second control information. That is, the terminal capability information defines a processing number (for example, K4′) of second control information for an SCS combination. Different from 4), the second SCS combination may be a combination of an SCS of a scheduling object and an SCS of a scheduled object.

The second SCS combination is, for example, {SCS 0, SCS 1, SCS 2 . . . , SCS m}, where the SCS 0 is an SCS of a scheduling object; the SCS 1 may be understood as an SCS of a scheduling object whose object ID is minimum/object ID is maximum/leftmost/rightmost/the first/the last and scheduled by mc-control; and so on for other SCSs.

The second SCS combination may alternatively be {SCS 0, SCS i}, where the SCS 0 is an SCS of a scheduling object, and the SCS i is an SCS of a scheduled object, and may be a maximum/minimum/specific SCS in SCSs of scheduled objects.

Further, if a same SCS exists in the second SCS combination, de-replication processing needs to be performed.

Optionally, in an example in which the object is a cell, if the SCS of the scheduled cell is a specific SCS of the cell, it may be understood that a mc-control number is restricted for {SCS of scheduling cell, SCS of scheduled cell}. If there are a plurality of {SCS of scheduling cell, SCS of scheduled cell} and a corresponding mc-control number, a possible implementation method is: a final mc-control number is a maximum/minimum value of all mc-control numbers.

6) A capability of processing second control information related to a quantity of scheduled objects.

The capability of processing the second control information may be a processing number of second control information. That is, the terminal capability information defines a processing number (for example, K5′) of second control information for a quantity of scheduled objects. For example, one mc-control schedules data transmission of two objects, and another mc-control schedules data transmission of three objects. The terminal capability information may separately define a processing capability of mc-control for scheduling two objects and a processing capability of mc-control for scheduling three objects.

7) A capability of processing second control information related to a total quantity of scheduling object and scheduled object.

The capability of processing the second control information may be a processing number of second control information. That is, the terminal capability information defines a processing number (for example, K6′) of second control information for a total quantity of scheduling object and scheduled object. For example, if one mc-control schedules data transmission of two objects, a total quantity of scheduling cell and scheduled cell is 3; and if another mc-control schedules data transmission of three objects, a total quantity of scheduling cell and scheduled cell is 4. The terminal capability information may separately define a processing capability of mc-control for a total quantity 3 of scheduling cells and scheduled cells and a processing capability of mc-control for a total quantity 4 of scheduling cells and scheduled cells.

8) A capability of processing second control information related to a relationship between an SCS of a scheduling object and an SCS of a scheduled object.

The capability of processing the second control information may be a processing number of second control information. That is, the terminal capability information defines a processing number (for example, K7′) of second control information for a relationship between an SCS of a scheduling object and an SCS of a scheduled object.

Optionally, the relationship between the SCS of the scheduling object and the SCS of the scheduled object includes at least one of the following:
an SCS of a scheduling object is higher than an SCS of a scheduled object;
an SCS of a scheduling object is equal to an SCS of a scheduled object;
an SCS of a scheduling object is lower than an SCS of a scheduled object;
an SCS of a scheduling object is different from an SCS of a scheduled object, that is, crossCarrierScheduling-DiffSCS;
an SCS of a scheduling object is the same as an SCS of a scheduled object, that is, crossCarrierScheduling-SameSCS, where for example, in this embodiment of this application, all scheduled objects and scheduling objects corresponding to mc-control correspond to crossCarrierScheduling-SameSCS; and
a ratio of an SCS of a scheduling object to an SCS of a scheduled object is L.

Optionally, L=a ratio of an SCS of a scheduling object to an SCS of a scheduled object; or L=a ratio of an SCS of a scheduled object to an SCS of a scheduling object. The SCS of the scheduled object may be: all SCSs of scheduled objects/a part of SCSs of scheduled objects/a maximum SCS of a scheduled object/a minimum SCS of a scheduled object.

9) A capability of processing second control information related to a second scheduling object.

The capability of processing the second control information may be a processing number of second control information. That is, the terminal capability information restricts a processing number (for example, K8′) of second control information for a scheduling object.

It should be noted that the second scheduling object may be a scheduling object or each scheduling object.

10) A capability of processing second control information related to a second scheduled object.

The capability of processing the second control information may be a processing number of second control information. That is, the terminal capability information restricts a processing number (for example, K9′) of second control information for a scheduled object.

It should be noted that the second scheduled object may be a scheduled object or each scheduled object.

11) A capability of processing second control information for TDD.

The capability of processing the second control information may be a processing number of second control information. That is, the terminal capability information restricts a processing number (for example, K10′) of second control information for TDD.

Optionally, TDD-specific may be understood as a scheduling object in TDD. That is, the terminal capability information restricts a processing number of second control information for a scheduling object in TDD.

12) A capability of processing second control information for FDD.

The capability of processing the second control information may be a processing number of second control information. That is, the terminal capability information restricts a processing number (for example, K11′) of second control information for FDD.

Optionally, FDD-specific may be understood as a scheduling object in FDD. That is, the terminal capability information restricts a processing number of second control information for a scheduling object in FDD.

13) A capability of processing second control information for a third frequency domain.

The third frequency domain is, for example, an FR 1 or a licensed band or a frequency domain in which a shared access technology does not exist. The capability of processing the second control information for the third frequency domain is, for example, a capability of processing corresponding second control information when a scheduling object and/or a scheduled object are/is in the FR 1 or the licensed band, and the processing capability may be a processing number of second control information.

14) A capability of processing second control information for a fourth frequency domain.

The fourth frequency domain is, for example, an FR 2 or an FR 3 or an unlicensed band or a frequency domain in which a shared access technology exists. The capability of processing the second control information for the fourth frequency domain is, for example, a capability of processing corresponding second control information when a scheduling object and/or a scheduled object are/is in the FR 2 or the FR 3 or the unlicensed band, and the processing capability may be a processing number of second control information.

15) A third monitoring capability.

The third monitoring capability is, for example, a slot-level monitoring capability, a monitoring capability corresponding to r15monitoringcapability, or a corresponding monitoring capability when r15monitoringcapability is not configured.

Optionally, in this embodiment of this application, all scheduled objects corresponding to mc-control correspond to a same monitoring capability, for example, all correspond to the first monitoring capability.

Optionally, in this embodiment of this application, all scheduled objects and scheduling objects corresponding to mc-control correspond to a same monitoring capability, for example, all correspond to the third monitoring capability.

16) A fourth monitoring capability.

The fourth monitoring capability is, for example, a span-level monitoring capability or a monitoring capability corresponding to r16monitoringcapability.

17) A capability of processing second control information related to a relationship between SCSs scheduled objects.

Optionally, the relationship between the SCSs of the scheduled objects may be:
at least two (preferably, all) SCSs of scheduled objects are different; or
at least two (preferably, all) SCSs of scheduled objects are the same.

It should be noted that the capability of processing the second control information may be a capability of monitoring/detecting/processing the second control information. A plurality of cases of the processing capability of the terminal for the second control information may simultaneously exist. When the processing capability represents a number of second control information processed by the terminal, values of processing numbers corresponding to different processing capabilities may be the same or different.

The terminal capability may be defined for different granularities, and the terminal may indicate the terminal capability for different granularities. In an optional embodiment, the terminal capability information includes at least one of the following:

(1) Terminal capability information corresponding to a scheduling object.

In this embodiment, the terminal capability information corresponding to the scheduling object may be understood as: corresponding capabilities need to be indicated for different scheduling objects, that is, being indicated for per scheduling cell.

(2) Terminal capability information corresponding to an SCS of a scheduling object. The terminal capability information corresponding to the SCS of the scheduling object may be understood as: corresponding capabilities need to be indicated for different SCSs of scheduling objects, that is, being indicated for per SCS of scheduling cell.

(3) Terminal capability information corresponding to an SCS of a scheduled object. The terminal capability information corresponding to the SCS of the scheduled object may be understood as: corresponding capabilities need to be indicated for different SCSs of scheduled objects. The SCS of the scheduled object may include a maximum/minimum/specific SCS of a scheduled object, that is, being indicated for per max/min/specific SCS of scheduled cell, and a corresponding capability needs to be indicated for a different maximum/minimum/specific SCS of a scheduled object.

(4) Terminal capability information corresponding to a case that an SCS of a scheduling object is higher than an SCS of a scheduled object, that is, being indicated for per SCS of scheduling cell>SCS of scheduled cell. It may be understood that a corresponding capability needs to be indicated for a case that an SCS of a scheduling cell>an SCS of a scheduled cell.

(5) Terminal capability information corresponding to a case that an SCS of a scheduling object is equal to an SCS of a scheduled object, that is, being indicated for per SCS of scheduling cell=SCS of scheduled cell. It may be understood that a corresponding capability needs to be indicated for a case that an SCS of a scheduling cell=an SCS of a scheduled cell.

(6) Terminal capability information corresponding to a case that an SCS of a scheduling object is lower than an SCS of a scheduled object, that is, being indicated for per SCS of scheduling cell<SCS of scheduled cell. It may be understood that a corresponding capability needs to be indicated for a case that an SCS of a scheduling cell<an SCS of a scheduled cell.

(7) Terminal capability information corresponding to a case that a ratio of an SCS of a scheduling object to an SCS of a scheduled object is L. That is, corresponding capabilities need to be indicated for different ratios of SCSs of scheduling objects to SCSs of scheduled objects. For example, one capability is reported for L=1, and another capability is reported for L=2.

L=a ratio of an SCS of a scheduling object to an SCS of a scheduled object; or L=a ratio of an SCS of a scheduled object to an SCS of a scheduling object.

(8) Terminal capability information corresponding to a quantity of supported scheduled objects. That is, corresponding capabilities need to be indicated for different quantities of supported scheduled objects. For example, one capability is reported for control information whose quantity of supported scheduled objects is 2, and another capability is reported for control information whose quantity of supported scheduled objects is 4.

(9) Terminal capability information corresponding to a total quantity of scheduling object and supported scheduled object. That is, corresponding capabilities need to be indicated for different total quantities of scheduling objects and supported scheduled objects. For example, if one control information can support two scheduled objects, a total quantity of scheduling object and supported scheduled object is 3, and one capability needs to be reported for the quantity 3. If another control information can support four scheduled objects, a total quantity of scheduling object and supported scheduled object is 5, and another capability needs to be reported for the quantity 5.

(10) Terminal capability information corresponding to a band, that is, being indicated for per band. Optionally, the band is a band in which a scheduling object is located.

(11) Terminal capability information corresponding to a band combination. The band combination is, for example, a band pair, a band combination, or a band list, that is, being indicated for per band pair, or per band combination or band list. The band pair, the band combination, and the band list may be a band pair in which a scheduling CC and/or a scheduled CC are/is located.

Optionally, the band combination includes a band in which a scheduled object is located and/or a band in which a scheduling object is located. For example, the band pair/combination/list includes a band in which a scheduled cell is located. The band pair/combination/list includes a band in which a scheduling cell is located and a band in which a scheduled cell is located.

(12) Terminal capability information corresponding to an object combination. The object combination is, for example, a cell combination or a cell list, that is, being indicated for per cell combination or cell list.

Optionally, the object combination includes a scheduled object; or the object combination includes a scheduling object and a scheduled object. For example, the cell combination/list includes a scheduled cell; or the cell combination/list includes a scheduling cell and a scheduled cell.

(13) Terminal capability information indicated corresponding to a feature set, that is, being indicated for per feature set. It may be understood that corresponding capabilities are indicated for a scheduling object related to one control information and all scheduling objects, that is, a capability may be indicated for each object and each object corresponds to the same capability, or one capability is uniformly indicated for the scheduling object and all the scheduling objects.

(14) Terminal capability information corresponding to a half duplex mode, that is, being indicated for per half duplex mode. Optionally, indication is performed for a scheduling object and/or a scheduled object in TDD or FDD, that is, indication is performed for per scheduling cell and/or scheduled cell in TDD or FDD.

(15) Terminal capability information corresponding to an SCS combination of a scheduling object and a scheduled object, that is, being indicated for different SCS combinations of scheduling objects and scheduled objects. For example, one capability is indicated for {SCS 2, SCS 3} being {maximum SCS in SCS of scheduling cell, SCS of scheduled cell}, and another capability is indicated for {SCS 2, SCS 3} being {minimum SCS in SCS of scheduling cell, SCS of scheduled cell}.

(16) Terminal capability information corresponding to a frequency range. The frequency range is, for example, a licensed frequency domain such as a frequency range (FR) 1, an FR 2, or an FR 3, an unlicensed frequency domain, a frequency domain with a shared access technology, or a frequency domain without a shared access technology.

The following uses an example in which the second control information is mc-DCI (that is, mc-control) to describe the terminal capability when the second control information is separately defined. It is assumed that a granularity of defining a capability of mc-DCI is one or more scheduling object slots (for example, scheduling cell slot) or a combination of an SCS of a scheduling object and an SCS of a scheduled object (for example, SCS of scheduling CC, max/min/specific SCS of scheduled CC). In an example in which the object is a CC:

1. mc-DCI scheduling a plurality of CC uplinks has at least one of the following capabilities:

(1) When the terminal reports a terminal capability of mc-DCI scheduling a plurality of CC uplinks, the following several capabilities are applicable to cross-carrier scheduling of SCSs in ascending order.

For a scheduling CC in FDD, a (for example, a=1) mc-DCI scheduling UL are processed per scheduling CC slot (Processing a mc-DCI scheduling UL per scheduling CC slot for FDD scheduling CC).

For a scheduling CC in TDD, b (for example, b=2) mc-DCI scheduling UL are processed per scheduling CC slot (Processing b mc-DCI scheduling UL per scheduling CC slot for TDD scheduling CC).

(2) When the terminal reports a terminal capability of mc-DCI scheduling a plurality of CC uplinks, the following several capabilities are applicable to cross-carrier scheduling of SCSs in descending order.

For a scheduling CC in FDD, c (for example, c=1) mc-DCI scheduling UL are processed per N consecutive scheduling CC slots (Processing c mc-DCI scheduling UL per N consecutive scheduling CC slot for FDD scheduling CC).

For a scheduling CC in TDD, d (for example, d=2) mc-DCI scheduling UL are processed per N consecutive scheduling CC slots (Processing d mc-DCI scheduling UL per N consecutive scheduling CC slot for TDD scheduling CC).

N is based on an SCS pair (SCS of scheduling CC, max/min/specific SCS of scheduled CC). For example, N=2 for (30, 15), (60, 30), and (120, 60); N=4 for (60, 5) and (120, 30); and N=8 for (120, 15).

For DCI (for example, mc-DCI) processing:
X mc-DCI are processed for each scheduling CC in UL. X is based on a combination of an SCS of a scheduling CC and an SCS of a scheduled CC (SCS of scheduling CC, max/min/specific SCS of scheduled CC). For example, X={1, 2, 4} for (15, 120), (15, 60), and (30, 120) kHz SCS; and X=(2) for (15, 30), (30, 60), (60, 120) kHz SCS, and X is applied to each slot of a scheduling CC.

2. mc-DCI scheduling a plurality of CC downlinks has at least one of the following capabilities:

(1) When the terminal reports a terminal capability of mc-DCI scheduling a plurality of CC downlinks, the following several capabilities are applicable to SCSs in ascending order.

For a scheduling CC in FDD, e (for example, e=1) mc-DCI scheduling DL are processed per scheduling CC slot (Processing e mc-DCI scheduling DL per scheduling CC slot for FDD scheduling CC).

For a scheduling CC in TDD, f (for example, f=1) mc-DCI scheduling DL are processed per scheduling CC slot (Processing f mc-DCI scheduling DL per scheduling CC slot for TDD scheduling CC).

(2) When the terminal reports a terminal capability of mc-DCI scheduling a plurality of CC downlinks, the following several capabilities are applicable to SCSs in descending order.

For a scheduling CC in FDD, g (for example, g=1) mc-DCI scheduling DL are processed per N consecutive scheduling CC slots (Processing g mc-DCI scheduling DL per N consecutive scheduling CC slot for FDD scheduling CC).

For a scheduling CC in TDD, h (for example, h=1) mc-DCI scheduling DL are processed per N consecutive scheduling CC slots (Processing h mc-DCI scheduling UL per N consecutive scheduling CC slot for TDD scheduling CC).

N is based on an SCS pair (SCS of scheduling CC, max/min/specific SCS of scheduled CC). For example, N=2 for (30, 15), (60, 30), and (120, 60); N=4 for (60, 5) and (120, 30); and N=8 for (120, 15).

For DCI (for example, mc-DCI) processing:

A processing capability is indicated. X mc-DCI are processed for each scheduling CC in DL. X is based on a combination of an SCS of a scheduling CC and an SCS of a scheduled CC (SCS of scheduling CC, max/min/specific SCS of scheduled CC). For example, X={1, 2, 4} for (15, 120), (15, 60), and (30, 120) kHz SCS; and X=(2) for (15, 30), (30, 60), (60, 120) kHz SCS, and X is applied to each slot of a scheduling CC.

3. mc-DCI scheduling at least one CC downlink and at least one CC uplink has at least one of the following capabilities:

(1) When the terminal reports a terminal capability of mc-DCI scheduling at least one CC downlink and at least one CC uplink, the following several capabilities are applicable to SCSs in ascending order.

For a scheduling CC in FDD, i (for example, i=1) mc-DCI scheduling DL and UL are processed per scheduling CC slot (Processing i mc-DCI scheduling DL and UL per scheduling CC slot for FDD scheduling CC).

For a scheduling CC in TDD, j (for example, j=1) mc-DCI scheduling DL and UL are processed per scheduling CC slot (Processing j mc-DCI scheduling DL and UL per scheduling CC slot for TDD scheduling CC).

(2) When the terminal reports a terminal capability of mc-DCI scheduling at least one CC downlink and at least one CC uplink, the following several capabilities are applicable to SCSs in descending order.

For a scheduling CC in FDD, k (for example, k=1) mc-DCI scheduling DL and UL are processed per N consecutive scheduling CC slots (Processing k mc-DCI scheduling DL and UL per N consecutive scheduling CC slot for FDD scheduling CC).

For a scheduling CC in TDD, 1 (for example, 1=1) mc-DCI scheduling DL and UL are processed per N consecutive scheduling CC slots (Processing 1 mc-DCI scheduling DL and UL per N consecutive scheduling CC slot for TDD scheduling CC).

N is based on an SCS pair (SCS of scheduling CC, max/min/specific SCS of scheduled CC). For example, N=2 for (30, 15), (60, 30), and (120, 60); N=4 for (60, 5) and (120, 30); and N=8 for (120, 15). For DCI (for example, mc-DCI) processing:

A processing capability is indicated. X mc-DCI are processed for each scheduling CC in DL and UL. X is based on a combination of an SCS of a scheduling CC and an SCS of a scheduled CC (SCS of scheduling CC, SCS of scheduled CC). For example, X={1, 2, 4} for (15, 120), (15, 60), and (30, 120) kHz SCS; and X=(2) for (15, 30), (30, 60), (60, 120) kHz SCS, and X is applied to each slot of a scheduling CC.

It should be noted that all the foregoing numbers of mc-DCI are examples, and may be replaced with other numbers of mc-DCI.

The following uses an example in which the second control information is mc-DCI (that is, mc-control) to describe the terminal capability when the second control information is separately defined. It is assumed that a granularity of defining a capability of mc-DCI is a value of a quantity (M) of scheduling objects that can be supported for one mc-DCI. In an example in which the object is a CC:

A. mc-DCI scheduling a plurality of CC uplinks has at least one of the following capabilities:

(1) When the terminal reports a terminal capability of mc-DCI scheduling a plurality of CC uplinks, the following several capabilities are applicable to scheduling of SCSs in ascending order.

For M′≥m (for example, m=3), a mc-DCI scheduling UL are processed per scheduling CC slot (for M′≥m, Processing a mc-DCI scheduling UL per scheduling CC slot).

For M′=n (for example, n=2), b mc-DCI scheduling UL are processed per scheduling CC slot (for M′=n, Processing b mc-DCI scheduling UL per scheduling CC slot).

(2) When the terminal reports a terminal capability of mc-DCI scheduling a plurality of CC uplinks, the following several capabilities are applicable to scheduling of SCSs in descending order.

For M′≥m, c mc-DCI scheduling UL are processed per scheduling CC slot (for M′≥m, Processing c mc-DCI scheduling UL per scheduling CC slot).

For M′=n, d mc-DCI scheduling UL are processed per scheduling CC slot (for M′=n, Processing d mc-DCI scheduling UL per scheduling CC slot).

For DCI (for example, mc-DCI) processing:

A processing capability is indicated. X mc-DCI are processed for each scheduling CC in UL. X is a value based on M′.

B. mc-DCI scheduling a plurality of CC downlinks has at least one of the following capabilities:

(1) When the terminal reports a terminal capability of mc-DCI scheduling a plurality of CC downlinks, the following several capabilities are applicable to SCSs in ascending order.

For M′≥m, e mc-DCI scheduling DL are processed per scheduling CC slot (for M′>m, Processing e mc-DCI scheduling DL per scheduling CC slot).

For M′=n, f mc-DCI scheduling DL are processed per scheduling CC slot (for M′=n, Processing f mc-DCI scheduling DL per scheduling CC slot).

(2) When the terminal reports a terminal capability of mc-DCI scheduling a plurality of CC downlinks, the following several capabilities are applicable to cross-carrier scheduling of SCSs in descending order.

For M′≥m, g mc-DCI scheduling DL are processed per scheduling CC slot (for M′≥m, Processing g mc-DCI scheduling DL per scheduling CC slot).

For M′=n, h mc-DCI scheduling DL are processed per scheduling CC slot (for M′=n, Processing h mc-DCI scheduling DL per scheduling CC slot).

For DCI (for example, mc-DCI) processing:

A processing capability is indicated. X mc-DCI are processed for each scheduling CC in DL. X is a value based on M′.

C. mc-DCI scheduling at least one CC downlink and at least one CC uplink has at least one of the following capabilities:

(1) When the terminal reports a terminal capability of mc-DCI scheduling at least one CC downlink and at least one CC uplink, the following several capabilities are applicable to SCSs in ascending order.

For M′≥m, i mc-DCI scheduling DL and UL are processed per scheduling CC slot (for M′≥m, Processing i mc-DCI scheduling DL and UL per scheduling CC slot).

For M′=n, j mc-DCI scheduling DL and UL are processed per scheduling CC slot (for M′=n, Processing j mc-DCI scheduling DL and UL per scheduling CC slot).

(2) When the terminal reports a terminal capability of mc-DCI scheduling at least one CC downlink and at least one CC uplink, the following several capabilities are applicable to SCSs in descending order.

For M′≥m, j mc-DCI scheduling DL and UL are processed per scheduling CC slot (for M′≥m, Processing j mc-DCI scheduling DL and UL per scheduling CC slot).

For M′=n, k mc-DCI scheduling DL and UL are processed per scheduling CC slot (for M′=2, Processing k mc-DCI scheduling DL and UL per scheduling CC slot).

For DCI (for example, mc-DCI) processing:

A processing capability is indicated. X mc-DCI are processed are for each scheduling CC in DL and UL. X is a value based on M′.

It should be noted that both M′≥m and M′=n are examples, and m and n may be any value. M′ is a quantity of objects that can be scheduled by one DCI, for example, a maximum quantity/a minimum quantity.

Optionally, M′ may be replaced with M′+1, that is, a UE capability is defined for M′+1; or may be replaced with M′+Y, that is, a UE capability is defined for M′+Y. Y may be a quantity of CCs converted by a scheduling CC. For example, if a ratio of an SCS of a scheduling CC to an SCS of a scheduled CC is L, Y=L or 1/L.

The following uses an example in which the second control information is mc-DCI to describe a definition of the terminal capability when mc-DCI is considered as DCI corresponding to a scheduling object or a part of the first control information (for example, also considered as unicast DCI).

When the terminal reports the foregoing terminal capability, the following several capabilities are applicable to cross-carrier scheduling of SCSs in ascending order.

For a scheduling CC in FDD, a (for example, a=1) DCI scheduling UL are processed per scheduling CC slot (Processing a unicast DCI scheduling UL per scheduling CC slot per scheduled CC for FDD scheduling CC).

For a scheduling CC in TDD, b (for example, b=2) DCI scheduling UL are processed per scheduling CC slot (Processing b unicast DCI scheduling UL per scheduling CC slot per scheduled CC for TDD scheduling CC).

In this case, it is assumed that a scheduling CC is located in an FDD band. Assuming that a CC 1 can be scheduled by sc-DCI of a scheduling CC, or can be scheduled by mc-DCI, for the CC 1, one sc-DCI or mc-DCI is processed within one scheduling CC slot.

It is assumed that a scheduling CC is located in a TDD band. Assuming that a CC 1 can be scheduled by sc-DCI of a scheduling CC, or can be scheduled by mc-DCI, for the CC 1, one sc-DCI and one mc-DCI are processed within one scheduling CC slot, or two sc-DCI or two mc-DCI are processed within one scheduling CC slot.

For DCI (for example, mc-DCI) processing:

A processing capability is indicated for UE cross-carrier scheduling in DL carrier aggregation. X DCI are processed for each scheduling CC. X is based on a combination of an SCS of a scheduling CC and an SCS of a scheduled CC (SCS of scheduling CC, SCS of scheduled CC). For example, X={1, 2, 4} for (15, 120), (15, 60), and (30, 120) kHz SCS; and X=(2) for (15, 30), (30, 60), (60, 120) kHz SCS, and X is applied to each slot of a scheduling CC.

In this case, it is assumed that a scheduling CC is 15 kHz. Assuming that a CC 1 (60 kHz) may be scheduled by sc-DCI of a scheduling CC or may be scheduled by mc-DCI, and X=1, for the CC 1, one sc-DCI or mc-DCI is directly processed within one scheduling CC slot.

It is assumed that a scheduling object is 15 kHz. Assuming that a CC 1 (30 kHz) may be scheduled by sc-DCI of a scheduling CC, or may be scheduled by mc-DCI, and X=2, for the CC 1, one sc-DCI and one mc-DCI are directly processed within one scheduling CC slot, or two sc-DCI or two mc-DCI are directly processed within one scheduling CC slot.

In this embodiment of this application, a capability of a terminal to process control information of different objects is defined. The terminal reports information about the terminal capability to a network side device, so that a scheduling constraint of the network side device during scheduling on the terminal meets the terminal capability. This avoids a problem of excessive UE complexity due to too much control information that needs processed by the terminal, and can also avoid a problem that information transmission fails due to discarding or missing detection of the control information, thereby ensuring that the terminal and the network side device have the same understanding of control information that can be actually processed.

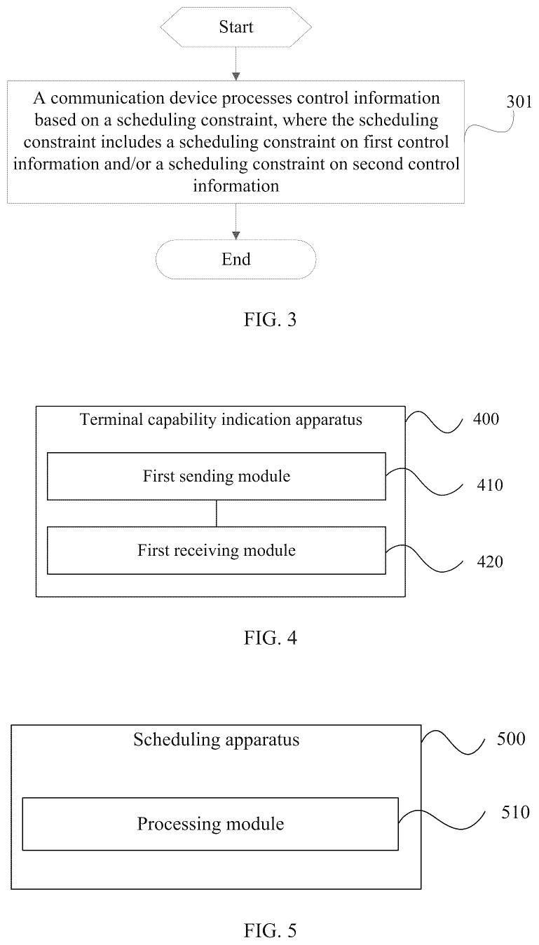

As shown in FIG. 3, an embodiment of this application further provides a scheduling method, applied to a communication device. The method includes:

Step 301: A communication device processes control information based on a scheduling constraint, where the scheduling constraint includes a scheduling constraint on first control information and/or a scheduling constraint on second control information, where
the first control information corresponds to N objects, and N is greater than or equal to 1; and
the second control information corresponds to M objects, and M is greater than or equal to 2.

In this embodiment, the communication device may be a terminal or a network side device. When the communication device is the network side device, that the network side device processes control information based on a scheduling constraint may mean that the network side device does not exceed the scheduling constraint in actual scheduling, that is, control information sent by the network side device to the terminal does not exceed the scheduling constraint. For example, if the scheduling constraint restricts a number of first control information to A, a number of first control information scheduled by the network side device does not exceed A.

When the communication device is a terminal, that the terminal processes control information based on a scheduling constraint may mean that control information received or monitored or detected or processed by the terminal does not exceed the scheduling constraint.

The scheduling constraint may be a number of scheduled control information. The control information may include the first control information and/or the second control information. The first control information corresponds to N objects. For example, the first control information is used to schedule/indicate/activate/deactivate the N objects. The second control information corresponds to M objects. For example, the second control information is used to schedule/indicate/activate/deactivate the M objects. Optionally, the first control information may be used to schedule data transmission of the N objects, and the second control information may be used to schedule data transmission of the M objects. That is, this embodiment of this application defines a scheduling constraint of the communication device on control information for scheduling data transmission of one and/or more objects.

The first control information corresponds to one or more objects, and the second control information corresponds to two or more objects. In this case, the first control information may include the second control information. When the first control information schedules two or more objects, the first control information is the second control information, or may be expressed as “mc-control”. When the first control information schedules data transmission of one object, the first control information may be expressed as “sc-control”.

Optionally, the scheduling constraint of the communication device on the first control information meets a processing capability of the terminal for the first control information, and the scheduling constraint of the communication device on the second control information meets a processing capability of the terminal for the second control information. For example, if the terminal supports processing of four first control information within a given time period, the scheduling constraint of the communication device on the first control information meets: a number of first control information processed within the given time period does not exceed 4.

In this embodiment of this application, a scheduling constraint of a communication device on control information is defined, and the scheduling constraint meets a capability of a terminal. This avoids a problem of excessive UE complexity due to too much control information that needs processed by the terminal, and can also avoid a problem that information transmission fails due to discarding or missing detection of the control information, thereby ensuring that the terminal and a network side device have the same understanding of control information that can be actually processed.

Optionally, the method further includes: obtaining terminal capability information, where the terminal capability information includes a processing capability of a terminal for the first control information and/or a processing capability of a terminal for the second control information, where the scheduling constraint meets a terminal capability indicated by the terminal capability information.

In this embodiment, the terminal reports the terminal capability information to the network side device. When the communication device is the network side device, the scheduling constraint may be determined based on the terminal capability, and the scheduling constraint meets the terminal capability. That is, the scheduling constraint of the network side device on the first control information meets the processing capability of the terminal for the first control information, and the scheduling constraint of the network side device on the second control information meets the processing capability of the terminal for the second control information, thereby ensuring that the terminal and the network side device have the same understanding of control information that can be actually processed.

When the communication device is the terminal, the scheduling constraint may be determined based on the terminal capability information. When processing control information, the terminal meets the scheduling constraint, and the scheduling constraint meets the terminal capability information.

Optionally, when the communication device is the network side device, the method further includes: determining, by the network side device, the scheduling constraint based on the terminal capability information. Specifically, the first control information sent by the network side device to the terminal meets the processing capability of the terminal for the first control information;
or
the second control information sent by the network side device to the terminal meets the processing capability of the terminal for the second control information.

Optionally, the scheduling constraint on the first control information includes at least one of the following:

1) A scheduling constraint on first control information within a first duration.

The first duration may be given duration, and may be set or defined based on the terminal capability. The scheduling constraint on the first control information may be a number of first control information scheduled to the terminal, and the scheduling constraint restricts a number (for example, K1) of first control information scheduled to the terminal within a given time period.

2) A scheduling constraint on first control information related to a first SCS.

The scheduling constraint on the first control information may be a number of first control information sent to the terminal, and the first SCS is, for example, an SCS 1. That is, the scheduling constraint restricts a number (for example, K2) of first control information scheduled by the network side device for an SCS.

Optionally, the first SCS may be:

a: An SCS of a scheduling object.

b. An SCS of a scheduled object.

c: A maximum/minimum SCS in SCSs of scheduled cells.

d: A maximum/minimum SCS in an SCS of a scheduling cell and an SCS of a scheduled cell.

e. A preset SCS of a scheduled cell.

f. A preset SCS of a scheduling cell.

g: A schedulable SCS.

h: A maximum/minimum/preset SCS in schedulable SCSs.

i: An SCS that can be used for a scheduling object.

j. A maximum/minimum/preset SCS in SCSs that can be used for scheduling objects.

k: A maximum/minimum/preset SCS in an object group (for example, a cell group).

l: An SCS that can be used. The SCS that can be used may be a supported SCS or a configurable SCS.

m: A maximum/minimum/preset SCS in SCSs that can be used, for example, a maximum/minimum/specific SCS in supported SCSs or configurable SCSs.

3) A scheduling constraint on first control information related to a first SCS pair.

The scheduling constraint on the first control information may be a number of first control information sent to the terminal. That is, the scheduling constraint restricts a scheduling number (for example, K3) of first control information for an SCS pair. The first SCS pair includes an SCS of a scheduling object and an SCS of a scheduled object, and the first SCS pair is, for example, {SCS 2, SCS 3}. Optionally, {SCS 2, SCS 3} is, for example, one of the following:
{SCS 2, SCS 3} is {SCS of scheduling cell, SCS of scheduled cell};
{SCS 2, SCS 3} is {maximum SCS in SCS of scheduling cell, SCS of scheduled cell}; and
{SCS 2, SCS 3} is {minimum SCS in SCS of scheduling cell, SCS of scheduled cell}.

4) A scheduling constraint on first control information related to a first SCS combination.

The scheduling constraint on the first control information may be a number of sent first control information. That is, the scheduling constraint restricts a scheduling number (for example, K4) of first control information for an SCS combination. The first SCS combination may be a combination of an SCS of a scheduling object and an SCS of a scheduled object. The first SCS combination is, for example, {SCS 0, SCS i}, where the SCS 0 is an SCS of a scheduling object, and the SCS i is an SCS of a scheduled object, and may be a maximum/minimum/specific SCS in SCSs of scheduled objects.

5) A scheduling constraint on first control information related to a quantity of scheduled objects.

The scheduling constraint on the first control information may be a number of first control information sent to the terminal. That is, the scheduling constraint restricts a sending number (for example, K5) of first control information for a quantity of scheduled objects. For example, one mc-control schedules data transmission of two objects, and another mc-control schedules data transmission of three objects. The scheduling constraint may separately restrict a number of mc-control for scheduling two objects and a number of mc-control for scheduling three objects.

6) A scheduling constraint on second control information related to a total quantity of scheduling object and scheduled object.

The scheduling constraint restricts a scheduling number (for example, K5) of first control information for a quantity of scheduled objects. For example, one mc-control schedules data transmission of two objects, and another mc-control schedules data transmission of three objects. The scheduling constraint may separately restrict a number of mc-control for scheduling two objects and a number of mc-control for scheduling three objects.

7) A scheduling constraint on first control information related to a relationship between an SCS of a scheduling object and an SCS of a scheduled object.

The scheduling constraint restricts a scheduling number (for example, K7) of first control information for a relationship between an SCS of a scheduling object and an SCS of a scheduled object.

Optionally, in an example in which the object is a cell, the relationship between the SCS of the scheduling object and the SCS of the scheduled object is one of the following:
the relationship between the SCSs is: an SCS of a scheduling cell>an SCS of a scheduled cell;
the relationship between the SCSs is: an SCS of a scheduling cell=an SCS of a scheduled cell;
the relationship between the SCSs is: an SCS of a scheduling cell<an SCS of a scheduled cell;
the relationship between the SCSs is: an SCS of a scheduling cell is different from an SCS of a scheduled cell;
the relationship between the SCSs is: an SCS of a scheduling cell is the same as an SCS of a scheduled cell; and
the relationship between the SCSs is: a ratio of an SCS of a scheduling cell to an SCS of a scheduled cell is L.

Optionally, L=a ratio of an SCS of a scheduling object to an SCS of a scheduled object; or L=a ratio of an SCS of a scheduled object to an SCS of a scheduling object.

8) A scheduling constraint on first control information related to a first scheduling object.

The scheduling constraint restricts a scheduling number (for example, K8) of first control information for a scheduling object. It should be noted that the first scheduling object may be a scheduling object or each scheduling object.

(9) A scheduling constraint on first control information related to a first scheduled object.

The scheduling constraint restricts a scheduling number (for example, K9) of first control information for a scheduled object. It should be noted that the first scheduled object may be a scheduled object or each scheduled object.

10) A scheduling constraint on first control information for time division multiplexing TDD.

The scheduling constraint restricts a scheduling number (for example, K10) of first control information for TDD. Optionally, TDD-specific may be understood as a scheduling object in TDD.

11) A scheduling constraint on first control information for frequency division multiplexing FDD.

The scheduling constraint restricts a scheduling number (for example, K11) of first control information for FDD. Optionally, FDD-specific may be understood as a scheduling object in FDD.

12) A scheduling constraint on first control information for a first frequency domain.

The first frequency domain is, for example, an FR 1 or a licensed band or a frequency domain in which a shared access technology does not exist. The scheduling constraint on the first control information for the first frequency domain is, for example, a scheduling constraint on corresponding first control information when a scheduling object and/or a scheduled object are/is in the FR 1 or the licensed band, and the scheduling constraint may be a processing number of first control information.

13) A scheduling constraint on first control information for a second frequency domain.

The second frequency domain is, for example, an FR 2 or an FR 3 or an unlicensed band or a frequency domain in which a shared access technology exists. The scheduling constraint on the first control information for the second frequency domain is, for example, a scheduling constraint on corresponding first control information when a scheduling object and/or a scheduled object are/is in the FR 2 or the FR 3 or the unlicensed band, and the scheduling constraint may be a processing number of first control information.

14) A scheduling constraint related to a first monitoring capability.

The first monitoring capability is, for example, a slot-level monitoring capability, a monitoring capability corresponding to r15monitoringcapability, or a corresponding monitoring capability when r15monitoringcapability is not configured. That is, the corresponding scheduling constraint is defined for the first monitoring capability.

Optionally, in this embodiment of this application, all scheduled objects corresponding to mc-control correspond to the first monitoring capability.

15) A scheduling constraint related to a second monitoring capability.

The second monitoring capability is, for example, a span-level monitoring capability or a monitoring capability corresponding to r16monitoringcapability. That is, the corresponding scheduling constraint is defined for the second monitoring capability.

16) A scheduling constraint on first control information related to a relationship between SCSs of scheduled objects.

Optionally, the relationship between the SCSs of the scheduled objects may be:
at least two (preferably, all) SCSs of scheduled objects are different; or
at least two (preferably, all) SCSs of scheduled objects are the same.

In this embodiment, the scheduling constraint of the communication device on the first control information meets the processing capability of the terminal for the first control information. In an example in which the communication device is the network side device, the network side device may determine, based on the processing capability of the terminal for the first control information, a number of first control information processed by the terminal; and determine, based on the number of first control information processed by the terminal, a number of sent first control information. The number of first control information sent by the network side device does not exceed the number of first control information processed by the terminal.

In an example in which the communication device is the terminal, the terminal may determine the processing number of first control information based on the scheduling constraint, so as to avoid exceeding the processing capability of the terminal.

Optionally, the scheduling constraint on the first control information includes a number of first control information.

In this embodiment, the scheduling constraint on the first control information may be a constraint on a scheduling number of first control information. Scheduling constraints may be different when quantities of objects scheduled by the first control information are different. Optionally, when the scheduling constraint on the first control information is a processing number of first control information, the scheduling constraint may be a maximum or minimum processing number of first control information.

Optionally, if the scheduling constraint on the first control information is related to target control information, and the target control information corresponds to M objects,

(1) One target control information corresponds to A first control information, where A is greater than or equal to 1.

In an example in which A is 1, that is, when the scheduling constraint on the first control information is being defined, one target control information is considered as one first control information. For example, if the scheduling constraint restricts the number of first control information scheduled by the network side device to 4, and the network side device needs to send mc-DCI (assumed to be used for scheduling four objects) to the terminal, the network side device may send four mc-DCI to the terminal, and the processing capability of the terminal for the first control information is met.

In an example in which A is 2, that is, when the scheduling constraint on the first control information is being defined, one target control information is considered as two first control information. For example, if the scheduling constraint restricts the number of first control information scheduled by the network side device to 4, and the network side device needs to send mc-DCI (assumed to be used for scheduling four objects) to the terminal, the network side device may send a maximum of two mc-DCI (equivalent to sending four first control information) to the terminal, and the processing capability of the terminal for the first control information is met.

Alternatively, (2) For each scheduled object, one target control information corresponds to one first control information.

In this embodiment, when the scheduling constraint on the first control information is being defined, for each scheduled object/transmission, one target control information is considered as one the first control information. In example in which the target control information is mc-DCI, the mc-DCI belongs to unicast DCI of a scheduled object.

Alternatively, (3) One target control information corresponds to M first control information.

When the target control information is used to schedule M objects, the target control information is equivalent to the second control information. When the scheduling constraint on the first control information is being defined, one target control information is considered as M first control information. In example in which M is 4, for example, if the scheduling constraint restricts a sending number of first control information to 4, and if the network side device needs to send mc-DCI (assumed to be used for scheduling four objects) to the terminal, the network side device sends one mc-DCI (equivalent to sending four first control information) to the terminal.

It should be noted that, the foregoing (1) to (3) are for conversion between a processing number of target control information and a processing number of first control information in a case that the scheduling constraint on the first control information is related to the target control information. For example, if A is 1 and one target control information corresponds to one the first control information, processing one target control information is equivalent to processing A first control information. For each scheduled object, if one target control information corresponds to one first control information, for each scheduled cell, processing one target control information is processing one first control information.

Optionally, for a first feature, one target control information corresponds to A first control information, where the first feature includes at least one of the following:
B time units, where B is greater than or equal to 1;
an SCS of a scheduling object;
an SCS of a scheduling object and an SCS of a scheduled object;
a relationship between an SCS of a scheduling object and an SCS of a scheduled object;
a scheduling object; and
a scheduled object.

For a meaning of each feature in the first feature, refer to the terminal capability indication method embodiment. Details are not described herein again.

Optionally, for a second feature, one target control information corresponds to one first control information for each scheduled object; and/or for a second feature, one target control information corresponds to M first control information, where
the second feature includes at least one of the following:
C time units, where C is greater than or equal to 1;
an SCS of a scheduling object;
a relationship between an SCS of a scheduling object and an SCS of a scheduled object; and
a scheduling object.

For a meaning of each feature in the second feature, refer to the terminal capability indication method embodiment. Details are not described herein again.

In an optional embodiment, in a case that the scheduling constraint includes the scheduling constraint on the second control information, the scheduling constraint further includes at least one of the following:
(1) a scheduling constraint on third control information;
(2) a joint scheduling constraint on the second control information and the first control information; and
(3) a joint scheduling constraint on the second control information and the third control information, where
the second control information corresponds to one object.

In this embodiment, the scheduling constraint may be a processing capability only for/considering the second control information (which may be expressed as mc-control); or may be a processing capability only for/considering the second control information (mc-control) and a scheduling constraint for/considering any one or more of the foregoing (1) to (3).

In this embodiment, a scheduling constraint on control information corresponding to a plurality of objects (in an example in which mc-control is mc-DCI) may be defined in two manners:

Manner 1: mc-DCI belongs to unicast DCI. The scheduling constraint may be jointly defined for mc-DCI and sc-DCI (that is, DCI for scheduling one object). For example, a defined scheduling constraint of the network side device on control information includes a joint scheduling constraint on mc-DCI and sc-DCI.

Manner 2: mc-DCI does not belong to unicast DCI. When the scheduling constraint of the network side device on the control information is being defined, a scheduling constraint on mc-DCI are additionally defined. For example, when the scheduling constraint is being defined, only a scheduling constraint on mc-DCI may be included, or a scheduling constraint on mc-DCI and a scheduling constraint on sc-DCI may be included; or a scheduling constraint on mc-DCI and a joint scheduling constraint on mc-DCI and sc-DCI may be included.

In this embodiment, when the scheduling constraint on the control information is being defined, the scheduling constraint on the second control information may be separately defined, and the scheduling constraint on the third control information and/or the first control information may be defined based on the separate definition of the scheduling constraint on the second control information, where the joint scheduling constraint on the second control information and the first control information may be defined, and/or the joint scheduling constraint on the second control information and the third control information may be defined.

Optionally, the scheduling constraint on the second control information includes at least one of the following:

1) A scheduling constraint on second control information within second duration.

The second duration may be set or defined based on a scheduling requirement for the second control information and a terminal processing capability. The scheduling constraint on the second control information may be a processing number of second control information. For example, the scheduling constraint restricts a number of second control information sent by the network side device to the terminal within a given time period and a number (for example, K1′) of second control information processed by the terminal within the given time period. The second duration may be one of the following: X consecutive slots, monitoring occasions, spans, symbols, duration, or periodicities.

2) A scheduling constraint on second control information related to a second SCS.

The second SCS is, for example, an SCS 1. That is, the scheduling constraint restricts a processing number (for example, K2′) of second control information for an SCS.

Optionally, the second SCS includes at least one of the following:
an SCS of a scheduling object;
an SCS of a scheduled object, where optionally, the SCS of the scheduled object may be a maximum SCS in SCSs of scheduled objects, or a minimum SCS in SCSs of scheduled objects; a maximum SCS in an SCS of a scheduling object and an SCS of a scheduled object;
a minimum SCS in an SCS of a scheduling object and an SCS of a scheduled object;
a target SCS of a scheduling object;
a target SCS of a scheduled object;
a schedulable SCS;
a first target SCS in schedulable SCSs;
an SCS that can be used for a scheduling object;
a second target SCS in SCSs that can be used for scheduling objects;
an SCS that can be used;
a third target SCS in SCSs that can be used; and
a fourth target SCS in an object group.

In this embodiment, for a meaning of the second SCS, refer to the terminal capability indication method embodiment. Details are not described herein again.

3) A scheduling constraint on second control information related to a second SCS pair.

The scheduling constraint on the second control information may be a processing number of second control information. That is, the scheduling constraint restricts a processing number (for example, K3′) of second control information for an SCS pair. The second SCS pair includes an SCS of a scheduling object and an SCS of a scheduled object, and the second SCS pair is, for example, {SCS 2, SCS 3}. Optionally, {SCS 2, SCS 3} is, for example, one of the following:
{SCS 2, SCS 3} is {SCS of scheduling cell, SCS of scheduled cell};
{SCS 2, SCS 3} is {maximum SCS in SCS of scheduling cell, SCS of scheduled cell}; and
{SCS 2, SCS 3} is {minimum SCS in SCS of scheduling cell, SCS of scheduled cell}.

4) A scheduling constraint on second control information related to an SCS combination of a scheduled object.

The scheduling constraint restricts a processing number (for example, K4′) of second control information for a scheduled SCS combination ({SCS 1, SCS 2 . . . , SCS m}). The SCS 1 may be understood as an SCS of a scheduling object whose object ID is minimum/object ID is maximum/leftmost/rightmost/the first/the last and scheduled by the second control information; and so on for other SCSs in the combination.

5) A scheduling constraint on second control information related to a second SCS combination.

The scheduling constraint on the second control information may be a processing number of second control information. That is, the scheduling constraint restricts a processing number (for example, K4′) of second control information for an SCS combination. Different from 4), the second SCS combination may be a combination of an SCS of a scheduling object and an SCS of a scheduled object.

6) A scheduling constraint on second control information related to a quantity of scheduled objects.

The scheduling constraint on the second control information may be a processing number of second control information. That is, the scheduling constraint restricts a processing number (for example, K5′) of second control information for a quantity of scheduled objects. For example, one mc-control schedules data transmission of two objects, and another mc-control schedules data transmission of three objects. The scheduling constraint may separately restrict a number of mc-control for scheduling two objects and a number of mc-control for scheduling three objects.

7) A scheduling constraint on second control information related to a total quantity of scheduling object and scheduled object.

The scheduling constraint on the second control information may be a processing number of second control information. That is, the scheduling constraint restricts a processing number (for example, K6′) of second control information for a total quantity of scheduling object and scheduled object. For example, if one mc-control schedules data transmission of two objects, a total quantity of scheduling object and scheduled object is 3; and if another mc-control schedules data transmission of three objects, a total quantity of scheduling object and scheduled object is 4. The scheduling constraint may separately restrict a number of mc-control for a total quantity 3 of scheduling object and scheduled objects and a number of mc-control for a total quantity 4 of scheduling object and scheduled objects.

8) A scheduling constraint on second control information related to a relationship between an SCS of a scheduling object and an SCS of a scheduled object.

Optionally, the relationship between the SCS of the scheduling object and the SCS of the scheduled object includes at least one of the following:
an SCS of a scheduling object is higher than an SCS of a scheduled object;
an SCS of a scheduling object is equal to an SCS of a scheduled object;
an SCS of a scheduling object is lower than an SCS of a scheduled object;
an SCS of a scheduling object is different from an SCS of a scheduled object;
an SCS of a scheduling object is the same as an SCS of a scheduled object; and
a ratio of an SCS of a scheduling object to an SCS of a scheduled object is L.

Optionally, L=a ratio of an SCS of a scheduling object to an SCS of a scheduled object; or L=a ratio of an SCS of a scheduled object to an SCS of a scheduling object.

The scheduling constraint restricts a processing number (for example, K7′) of second control information for a relationship between an SCS of a scheduling object and an SCS of a scheduled object.

9) A scheduling constraint on second control information related to a second scheduling object.

The second scheduling object may be a scheduling object or each scheduling object. The scheduling constraint restricts a processing number (for example, K8′) of second control information for a scheduling object.

10) A scheduling constraint on second control information related to a second scheduled object.

The second scheduled object may be a scheduled object or each scheduled object. The scheduling constraint restricts a processing number (for example, K9′) of second control information for a scheduled object.

11) A scheduling constraint on second control information for TDD.

The scheduling constraint a processing number (for example, K10′) of second control information for TDD.

Optionally, TDD-specific may be understood as a scheduling object in TDD.

12) A scheduling constraint on second control information for FDD.

The scheduling constraint restricts a processing number (for example, K11′) of second control information for FDD.

Optionally, FDD-specific may be understood as a scheduling object in FDD.

13) A scheduling constraint on second control information for a third frequency domain.

The third frequency domain is, for example, an FR 1 or a licensed band or a frequency domain in which a shared access technology does not exist. The scheduling constraint on the second control information for the third frequency domain is, for example, a scheduling constraint on corresponding second control information when a scheduling object and/or a scheduled object are/is in the FR 1 or the licensed band, and the scheduling constraint may be a processing number of second control information.

14) A scheduling constraint on second control information for a fourth frequency domain.

The fourth frequency domain is, for example, an FR 2 or an FR 3 or an unlicensed band or a frequency domain in which a shared access technology exists. The scheduling constraint on the second control information for the fourth frequency domain is, for example, a scheduling constraint on corresponding second control information when a scheduling object and/or a scheduled object are/is in the FR 2 or the FR 3 or the unlicensed band, and the scheduling constraint may be a processing number of second control information.

15) A third monitoring capability.

The third monitoring capability is, for example, a slot-level monitoring capability, a monitoring capability corresponding to r15monitoringcapability, or a corresponding monitoring capability when r15monitoringcapability is not configured.

Optionally, in this embodiment of this application, all scheduled objects corresponding to mc-control correspond to the first monitoring capability.

16) A fourth monitoring capability.

The fourth monitoring capability is, for example, a span-level monitoring capability or a monitoring capability corresponding to r16monitoringcapability.

17) A scheduling constraint on second control information related to a relationship between SCSs of scheduled objects.

Optionally, the relationship between the SCSs of the scheduled objects may be:
at least two (preferably, all) SCSs of scheduled objects are different; or
at least two (preferably, all) SCSs of scheduled objects are the same.

The scheduling constraint may be defined for different granularities. In an optional embodiment, the scheduling constraint includes at least one of the following:

(1) A scheduling constraint for a scheduling object.

In this embodiment, the scheduling constraint for the scheduling object may be understood as: corresponding scheduling constraints need to be defined for different scheduling objects, that is, being indicated for per scheduling cell.

(2) A scheduling constraint for an SCS of a scheduling object. The scheduling constraint for the SCS of a scheduling object may be understood as: corresponding scheduling constraints need to be defined for different SCSs of scheduling objects, that is, being indicated for per SCS of scheduling cell.

(3) A scheduling constraint for an SCS of a scheduled object. The scheduling constraint for the SCS of the scheduled object may be understood as: corresponding scheduling constraints need to be defined for different SCSs of scheduled objects.

(4) A scheduling constraint in a case that an SCS of a scheduling object is higher than an SCS of a scheduled object, that is, being indicated for per SCS of scheduling cell>SCS of scheduled cell. It may be understood that a corresponding scheduling constraint needs to be defined for a case that an SCS of a scheduling cell>an SCS of a scheduled cell.

(5) A scheduling constraint in a case that an SCS of a scheduling object is equal to an SCS of a scheduled object, that is, being indicated for per SCS of scheduling cell=SCS of scheduled cell.

(6) Terminal capability information corresponding to a case that an SCS of a scheduling object is lower than an SCS of a scheduled object, that is, being indicated for per SCS of scheduling cell<SCS of scheduled cell.

(7) A scheduling constraint in the case that a ratio of an SCS of a scheduling object to an SCS of a scheduled object is L. That is, corresponding scheduling constraints need to be defined for different ratios of SCSs of scheduling objects to SCSs of scheduled objects. For example, one restricted number of control information is defined for L=1, and another restricted number of control information is defined for L=2.

L=a ratio of an SCS of a scheduling object to an SCS of a scheduled object; or L=a ratio of an SCS of a scheduled object to an SCS of a scheduling object.

(8) A scheduling constraint for a quantity of supported scheduled objects. That is, corresponding scheduling constraints need to be defined for different quantities of supported scheduled objects.

(9) A scheduling constraint for a total quantity of scheduling object and supported scheduled object. That is, corresponding scheduling constraints need to be defined for different total quantities of scheduling objects and supported scheduled objects. For example, if one control information can support two scheduled objects, a total quantity of scheduling object and supported scheduled object is 3, and a restricted number of control information needs to be defined for the quantity 3. If another control information can support four scheduled objects, a total quantity of scheduling object and supported scheduled object is 5, and another restricted number of control information needs to be defined for the quantity 5.

(10) A scheduling constraint for a band, that is, being indicated for per band.

(11) A scheduling constraint for a band combination, that is, being indicated for per band pair, or per band combination or band list.

(12) A scheduling constraint for an object combination, that is, being indicated for per cell combination or cell list.

(13) A scheduling constraint indicated for a feature set, that is, being indicated for per feature set. It may be understood that corresponding scheduling constraints are defined for a scheduling object related to one control information and all scheduling objects, that is, a corresponding scheduling constraint may be defined for each object and each object corresponds to the same scheduling constraint, or one scheduling constraint is uniformly defined for the scheduling object and all the scheduling objects.

(14) A scheduling constraint for a half duplex mode, being indicated for per half duplex mode. Optionally, a scheduling constraint may be defined for a scheduling object in TDD or FDD.

(15) A scheduling constraint for an SCS combination of a scheduling object and a scheduled object. That is, scheduling constraints are separately defined for different SCS combinations of scheduling objects and scheduled objects. For example, one scheduling constraint is defined for {SCS 2, SCS 3} being {maximum SCS in SCS of scheduling cell, SCS of scheduled cell}, and another scheduling constraint is defined for {SCS 2, SCS 3} being {minimum SCS in SCS of scheduling cell, SCS of scheduled cell}.

(16) A scheduling constraint for a frequency range. The frequency range is, for example, a licensed frequency domain such as an FR 1, an FR 2, or an FR 3, an unlicensed frequency domain, a frequency domain with a shared access technology, or a frequency domain without a shared access technology.

Optionally, in this embodiment of this application, the scheduling object and the scheduled object correspond to a same terminal capability or a same scheduling constraint.

Optionally, at least two scheduled objects correspond to a same terminal capability or a same scheduling constraint.

Preferably, when the terminal capability or the scheduling constraint is the following granularity, the foregoing terminal capability or the scheduling constraint needs to be met:
terminal capability information or a scheduling constraint for a scheduling object;
terminal capability information or a scheduling constraint for an SCS of a scheduling object;
terminal capability information or a scheduling constraint for an SCS of a scheduled object;
terminal capability information or a scheduling constraint in a case that an SCS of a scheduling object is higher than an SCS of a scheduled object;
terminal capability information or a scheduling constraint in a case that an SCS of a scheduling object is equal to an SCS of a scheduled object;
terminal capability information or a scheduling constraint in a case that an SCS of a scheduling object is lower than an SCS of a scheduled object;
terminal capability information or a scheduling constraint in a case that a ratio of an SCS of a scheduling object to an SCS of a scheduled object is L;
terminal capability information or a scheduling constraint for a quantity of supported scheduled objects;
terminal capability information or a scheduling constraint for a total quantity of scheduling object and supported scheduled object;
terminal capability information or a scheduling constraint for a band;
terminal capability information or a scheduling constraint for a band combination; terminal capability information or a scheduling constraint for an object combination;
terminal capability information or a scheduling constraint indicated for a feature set;
terminal capability information or a scheduling constraint for a half duplex mode;
terminal capability information or a scheduling constraint for a frequency range; and
terminal capability information or a scheduling constraint for an SCS combination of a scheduling object and a scheduled object.

In this embodiment of this application, a scheduling constraint when a communication device processes control information is defined, and the scheduling constraint meets a capability of a terminal. This avoids a problem of excessive UE complexity due to too much control information that needs processed by the terminal, and can also avoid a problem that information transmission fails due to discarding or missing detection of the control information, thereby ensuring that the terminal and a network side device have the same understanding of control information that can be actually processed.

The terminal capability indication method provided in the embodiments of this application may be performed by a terminal capability indication apparatus. In the embodiments of this application, an example in which the terminal capability indication apparatus performs the terminal capability indication method is used as an example to describe the terminal capability indication apparatus provided in the embodiments of this application.

As shown in FIG. 4, an embodiment of this application provides a terminal capability indication apparatus 400, applied to a terminal and including:
a first sending module 410, configured to send terminal capability information to a network side device, where the terminal capability information includes a processing capability of the terminal for first control information and/or a processing capability of the terminal for second control information; and
a first receiving module 420, configured to receive at least two scheduling information, where the at least two scheduling information meet a requirement corresponding to the terminal capability information, and the scheduling information is at least one of the first control information and the second control information, where
the first control information corresponds to N objects, and N is greater than or equal to 1; and
the second control information corresponds to M objects, and M is greater than or equal to 2.

Optionally, the processing capability of the terminal for the first control information includes at least one of the following:
a capability of processing first control information within a first duration;
a capability of processing first control information related to a first SCS;
a capability of processing first control information related to a first SCS pair;
a capability of processing first control information related to a first SCS combination;
a capability of processing first control information related to a quantity of scheduled objects;
a capability of processing first control information related to a total quantity of scheduling object and scheduled object;
a capability of processing first control information related to a relationship between an SCS of a scheduling object and an SCS of a scheduled object;
a capability of processing first control information related to a relationship between SCSs of scheduled objects;
a capability of processing first control information related to a first scheduling object;
a capability of processing first control information related to a first scheduled object;
a capability of processing first control information for time division multiplexing TDD;
a capability of processing first control information for frequency division multiplexing FDD;
a capability of processing first control information for a first frequency domain;
a capability of processing first control information for a second frequency domain;
a first monitoring capability; and
a second monitoring capability.

Optionally, the capability of processing the first control information includes a number of first control information.

Optionally, if the capability of processing the first control information is related to target control information, and the target control information corresponds to M objects,
one target control information corresponds to A first control information, where A is greater than or equal to 1; or
for each scheduled object, one target control information corresponds to one first control information; or
one target control information corresponds to M first control information.

Optionally, for a first feature, one target control information corresponds to A first control information, where
the first feature includes at least one of the following:
B time units, where B is greater than or equal to 1;
an SCS of a scheduling object;
an SCS of a scheduling object and an SCS of a scheduled object;
a relationship between an SCS of a scheduling object and an SCS of a scheduled object;
a scheduling object; and
a scheduled object.

Optionally, for a second feature, one target control information corresponds to one first control information for each scheduled object; and/or for a second feature, one target control information corresponds to M first control information, where
the second feature includes at least one of the following:
C time units, where C is greater than or equal to 1;
an SCS of a scheduling object;
a relationship between an SCS of a scheduling object and an SCS of a scheduled object; and
a scheduling object.

Optionally, in a case that the terminal capability information includes the processing capability of the terminal for the second control information, the terminal capability information further includes at least one of the following:
a processing capability for third control information;
a joint processing capability for the second control information and the first control information; and
a joint processing capability for the second control information and the third control information, where
the third control information corresponds to one object.

Optionally, the processing capability of the terminal for the second control information includes at least one of the following:
a capability of processing second control information within second duration;
a capability of processing second control information related to a second SCS;
a capability of processing second control information related to a second SCS pair;
a capability of processing second control information related to an SCS combination of a scheduled object;
a capability of processing second control information related to a second SCS combination;
a capability of processing second control information related to a quantity of scheduled objects;
a capability of processing second control information related to a total quantity of scheduling object and scheduled object;
a capability of processing second control information related to a relationship between an SCS of a scheduling object and an SCS of a scheduled object;
a capability of processing second control information related to a relationship between SCSs of scheduled objects;
a capability of processing second control information related to a second scheduling object;
a capability of processing second control information related to a second scheduled object;
a capability of processing second control information for TDD;
a capability of processing second control information for FDD;
a capability of processing second control information for a third frequency domain;
a capability of processing second control information for a fourth frequency domain;
a third monitoring capability; and
a fourth monitoring capability.

Optionally, the second SCS includes at least one of the following:
an SCS of a scheduling object;
an SCS of a scheduled object;
a maximum SCS in an SCS of a scheduling object and an SCS of a scheduled object;
a minimum SCS in an SCS of a scheduling object and an SCS of a scheduled object;
a target SCS of a scheduling object;
a target SCS of a scheduled object;
a schedulable SCS;
a first target SCS in schedulable SCSs;
an SCS that can be used for a scheduling object;
a second target SCS in SCSs that can be used for scheduling objects;
an SCS that can be used;
a third target SCS in SCSs that can be used; and
a fourth target SCS in an object group.

Optionally, the relationship between the SCS of the scheduling object and the SCS of the scheduled object includes at least one of the following:
an SCS of a scheduling object is higher than an SCS of a scheduled object;
an SCS of a scheduling object is equal to an SCS of a scheduled object;
an SCS of a scheduling object is lower than an SCS of a scheduled object;
an SCS of a scheduling object is different from an SCS of a scheduled object;
an SCS of a scheduling object is the same as an SCS of a scheduled object; and
a ratio of an SCS of a scheduling object to an SCS of a scheduled object is L.

Optionally, the terminal capability information includes at least one of the following:
terminal capability information corresponding to a scheduling object;
terminal capability information corresponding to an SCS of a scheduling object;
terminal capability information corresponding to an SCS of a scheduled object;
terminal capability information corresponding to a case that an SCS of a scheduling object is higher than an SCS of a scheduled object;
terminal capability information corresponding to a case that an SCS of a scheduling object is equal to an SCS of a scheduled object;
terminal capability information corresponding to a case that an SCS of a scheduling object is lower than an SCS of a scheduled object;
terminal capability information corresponding to a case that a ratio of an SCS of a scheduling object to an SCS of a scheduled object is L;
terminal capability information corresponding to a quantity of supported scheduled objects;
terminal capability information corresponding to a total quantity of scheduling object and supported scheduled object;
terminal capability information corresponding to a band;
terminal capability information corresponding to a band combination;
terminal capability information corresponding to an object combination;
terminal capability information indicated corresponding to a feature set;
terminal capability information corresponding to a half duplex mode;
terminal capability information corresponding to an SCS combination of a scheduling object and a scheduled object; and
terminal capability information corresponding to a frequency range.

In this embodiment of this application, a capability of a terminal to process control information of different objects is defined. The terminal reports information about the terminal capability to a network side device, so that a scheduling constraint of the network side device during scheduling on the terminal meets the terminal capability. This avoids a problem of excessive UE complexity due to too much control information that needs processed by the terminal, and can also avoid a problem that information transmission fails due to discarding or missing detection of the control information, thereby ensuring that the terminal and the network side device have the same understanding of control information that can be actually processed.

The scheduling method provided in the embodiments of this application may be performed a scheduling apparatus. In the embodiments of this application, an example in which the scheduling apparatus performs the scheduling method is used as an example to describe the scheduling apparatus provided in the embodiments of this application.

As shown in FIG. 5, an embodiment of this application provides a scheduling apparatus 500, applied to a communication device. The communication device may be a network side device or a terminal and includes:
a processing module 510, configured to process control information based on a scheduling constraint, where the scheduling constraint includes a scheduling constraint on first control information and/or a scheduling constraint on second control information, where
the first control information corresponds to N objects, and N is greater than or equal to 1; and
the second control information corresponds to M objects, and M is greater than or equal to 2.

Optionally, the apparatus further includes:
a first obtaining module, configured to obtain terminal capability information, where the terminal capability information includes a processing capability of a terminal for the first control information and/or a processing capability of a terminal for the second control information, where
the scheduling constraint meets a terminal capability indicated by the terminal capability information.

Optionally, the scheduling constraint on the first control information includes at least one of the following:
a scheduling constraint on first control information within a first duration;
a scheduling constraint on first control information related to a first SCS;
a scheduling constraint on first control information related to a first SCS pair;
a scheduling constraint on first control information related to a first SCS combination;
a scheduling constraint on first control information related to a quantity of scheduled objects;
a scheduling constraint on second control information related to a total quantity of scheduling object and scheduled object;
a scheduling constraint on first control information related to a relationship between an SCS of a scheduling object and an SCS of a scheduled object;
a scheduling constraint on first control information related to a relationship between SCSs of scheduled objects;
a scheduling constraint on first control information related to a first scheduling object;
a scheduling constraint on first control information related to a first scheduled object;
a scheduling constraint on first control information for time division multiplexing TDD;
a scheduling constraint on first control information for frequency division multiplexing FDD;
a scheduling constraint on first control information for a first frequency domain;
a scheduling constraint on first control information for a second band;
a scheduling constraint related to a first monitoring capability; and
a scheduling constraint related to a second monitoring capability.

Optionally, the scheduling constraint on the first control information includes a number of first control information.

Optionally, if the scheduling constraint on the first control information is related to target control information, and the target control information corresponds to M objects,
one target control information corresponds to A first control information, where A is greater than or equal to 1; or
for each scheduled object, one target control information corresponds to one first control information; or
one target control information corresponds to M first control information.

Optionally, for a first feature, one target control information corresponds to A first control information, where
the first feature includes at least one of the following:
B time units, where B is greater than or equal to 1;
an SCS of a scheduling object;
an SCS of a scheduling object and an SCS of a scheduled object;
a relationship between an SCS of a scheduling object and an SCS of a scheduled object;
a scheduling object; and
a scheduled object.

Optionally, for a second feature, one target control information corresponds to one first control information for each scheduled object; and/or for a second feature, one target control information corresponds to M first control information, where
the second feature includes at least one of the following:
C time units, where C is greater than or equal to 1;
an SCS of a scheduling object;
a relationship between an SCS of a scheduling object and an SCS of a scheduled object; and
a scheduling object.

Optionally, in a case that the scheduling constraint includes the scheduling constraint on the second control information, the scheduling constraint further includes at least one of the following:
a scheduling constraint on third control information;
a joint scheduling constraint on the second control information and the first control information; and
a joint scheduling constraint on the second control information and the third control information, where
the second control information corresponds to one object.

Optionally, the scheduling constraint on the second control information includes at least one of the following:
a scheduling constraint on second control information within second duration;
a scheduling constraint on second control information related to a second SCS;
a scheduling constraint on second control information related to a second SCS pair;
a scheduling constraint on second control information related to an SCS combination of a scheduled object;
a scheduling constraint on second control information related to a second SCS combination;
a scheduling constraint on second control information related to a quantity of scheduled objects;
a scheduling constraint on second control information related to a total quantity of scheduling object and scheduled object;
a scheduling constraint on second control information related to a relationship between an SCS of a scheduling object and an SCS of a scheduled object;
a scheduling constraint on second control information related to a relationship between SCSs of scheduled objects;
a scheduling constraint on second control information related to a second scheduling object;
a scheduling constraint on second control information related to a second scheduled object;
a scheduling constraint on second control information for TDD;
a scheduling constraint on second control information for FDD;
a scheduling constraint on second control information for a third frequency domain;
a scheduling constraint on second control information for a fourth frequency domain;
a scheduling constraint related to a third monitoring capability; and
a scheduling constraint related to a fourth monitoring capability.

Optionally, the second SCS includes at least one of the following:
an SCS of a scheduling object;
an SCS of a scheduled object;
a maximum SCS in SCSs of scheduled objects;
a minimum SCS in SCSs of scheduled objects;
a maximum SCS in an SCS of a scheduling object and an SCS of a scheduled object;
a minimum SCS in an SCS of a scheduling object and an SCS of a scheduled object;
a target SCS of a scheduling object;
a target SCS of a scheduled object;
a schedulable SCS;
a first target SCS in schedulable SCSs;
an SCS that can be used for a scheduling object;
a second target SCS in SCSs that can be used for scheduling objects;
an SCS that can be used;
a third target SCS in SCSs that can be used; and
a fourth target SCS in an object group.

Optionally, the scheduling constraint includes at least one of the following:
a scheduling constraint for a scheduling object;
a scheduling constraint for an SCS of a scheduling object;
a scheduling constraint for an SCS of a scheduled object;
a scheduling constraint in a case that an SCS of a scheduling object is higher than an SCS of a scheduled object;
a scheduling constraint in a case that an SCS of a scheduling object is equal to an SCS of a scheduled object;
terminal capability information corresponding to a case that an SCS of a scheduling object is lower than an SCS of a scheduled object;
a scheduling constraint in a case that a ratio of an SCS of a scheduling object to an SCS of a scheduled object is L;
a scheduling constraint for a quantity of supported scheduled objects;
a scheduling constraint for a total quantity of scheduling object and supported scheduled object;
a scheduling constraint for a band;
a scheduling constraint for a band combination;
a scheduling constraint for an object combination;
a scheduling constraint for a feature set indication;
a scheduling constraint for a half duplex mode;
a scheduling constraint for an SCS combination of a scheduling object and a scheduled object; and
a scheduling constraint for a frequency range.

In this embodiment of this application, a scheduling constraint of a communication device on control information is defined, and the scheduling constraint meets a capability of a terminal. This avoids a problem of excessive UE complexity due to too much control information that needs processed by the terminal, and can also avoid a problem that information transmission fails due to discarding or missing detection of the control information, thereby ensuring that the terminal and a network side device have the same understanding of control information that can be actually processed.

The terminal capability indication apparatus or the scheduling apparatus in the embodiments of this application may be an electronic device, for example, an electronic device having an operating system, or may be a component in the electronic device, for example, an integrated circuit or a chip. The electronic device may be a terminal, or another device other than the terminal. For example, the terminal may include but is not limited to the foregoing listed type of the terminal 11. The another device may be a server, a network attached storage (NAS), or the like. This is not specifically limited in the embodiments of this application.

The terminal capability indication apparatus provided in the embodiments of this application can implement the processes implemented in the method embodiment of FIG. 2, and achieve a same technical effect. The scheduling apparatus provided in the embodiments of this application can implement the processes implemented in the method embodiment of FIG. 3, and achieve a same technical effect. To avoid repetition, details are not described herein again.

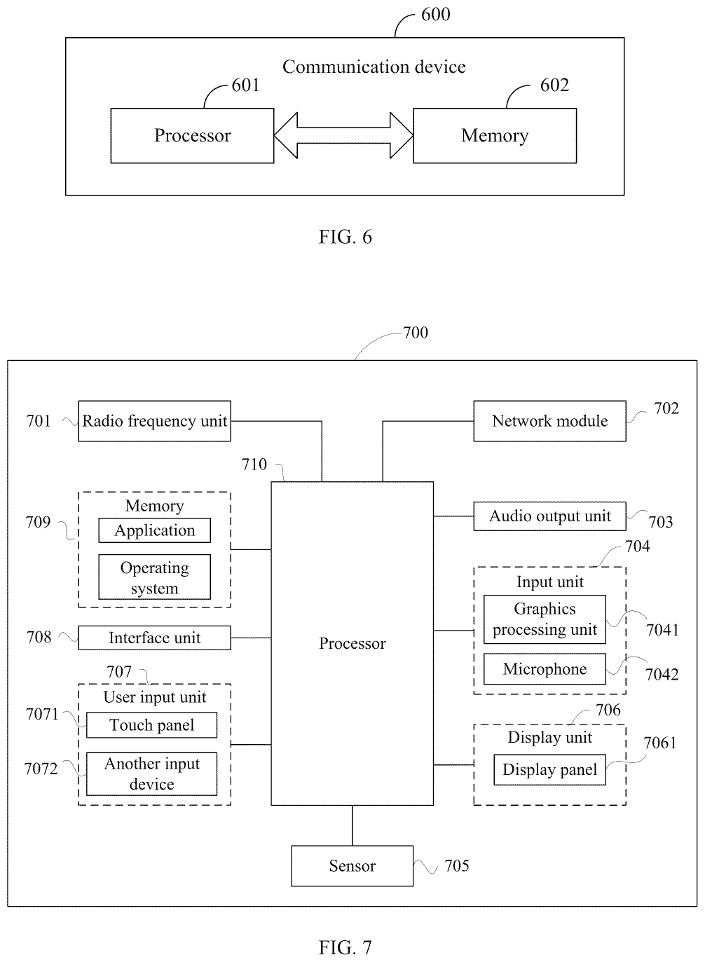

Optionally, as shown in FIG. 6, an embodiment of this application further provides a communication device 600, including a processor 601 and a memory 602. The memory 602 stores a program or an instruction that can be run on the processor 601. For example, when the communication device 600 is a terminal, the program or the instruction is executed by the processor 601 to implement the steps of the foregoing terminal capability indication method embodiment or the steps of the foregoing scheduling method embodiment, and a same technical effect can be achieved. When the communication device 600 is a network side device, the program or the instruction is executed by the processor 601 to implement the steps of the foregoing scheduling method embodiment, and a same technical effect can be achieved. To avoid repetition, details are not described herein again.

An embodiment of this application further provides a terminal, including a processor and a communication interface. The communication interface is configured to: send terminal capability information to a network side device, where the terminal capability information includes a processing capability of the terminal for first control information and/or a processing capability of the terminal for second control information; and receive at least two scheduling information, where the at least two scheduling information meet a requirement corresponding to the terminal capability information, and the scheduling information includes at least one of the first control information and the second control information, where the first control information corresponds to N objects, and N is greater than or equal to 1; and the second control information corresponds to M objects, and M is greater than or equal to 2. This terminal embodiment corresponds to the foregoing method embodiment on the terminal side. Each implementation process and implementation of the foregoing method embodiment may be applicable to this terminal embodiment, and a same technical effect can be achieved. Specifically, FIG. 7 is a schematic diagram of a hardware structure of a terminal according to an embodiment of this application.

The terminal 700 includes but is not limited to components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include the power supply (for example, a battery) that supplies power to each component. The power supply may be logically connected to the processor 710 by using a power supply management system, so as to manage functions such as charging, discharging, and power consumption by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that, in this embodiment of this application, the input unit 704 may include a graphics processing unit (GPU) 7041 and a microphone 7042, and the graphics processing unit 7041 processes image data of a still image or a video that is obtained by an image capturing apparatus (for example, a camera) in a video capturing mode or an image capturing mode. The display unit 706 may include a display panel 7061. The display panel 7061 may be configured in a form such as a liquid crystal display or an organic light-emitting diode. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (for example, a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Usually, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 709 in this embodiment of this application includes but is not limited to these memories and a memory of any other proper type.

The processor 710 may include one or more processing units. Optionally, an application processor and a modem processor are integrated into the processor 710. The application processor mainly processes an operating system, a user interface, an application, and the like. The modem processor mainly processes a wireless communication signal, for example, a baseband processor. It can be understood that, alternatively, the modem processor may not be integrated into the processor 710.

The radio frequency unit 701 is configured to send terminal capability information to a network side device, where the terminal capability information includes a processing capability of the terminal for first control information and/or a processing capability of the terminal for second control information; and
receive at least two scheduling information, where the at least two scheduling information meet a requirement corresponding to the terminal capability information, and the scheduling information is at least one of the first control information and the second control information, where
the first control information corresponds to N objects, and N is greater than or equal to 1; and
the second control information corresponds to M objects, and M is greater than or equal to 2.

Optionally, the processing capability of the terminal for the first control information includes at least one of the following:
a capability of processing first control information within a first duration;
a capability of processing first control information related to a first SCS;
a capability of processing first control information related to a first SCS pair;
a capability of processing first control information related to a first SCS combination;
a capability of processing first control information related to a quantity of scheduled objects;
a capability of processing first control information related to a total quantity of scheduling object and scheduled object;
a capability of processing first control information related to a relationship between an SCS of a scheduling object and an SCS of a scheduled object;
a capability of processing first control information related to a relationship between SCSs of scheduled objects;
a capability of processing first control information related to a first scheduling object;
a capability of processing first control information related to a first scheduled object;
a capability of processing first control information for time division multiplexing TDD;
a capability of processing first control information for frequency division multiplexing FDD;
a capability of processing first control information for a first frequency domain;
a capability of processing first control information for a second frequency domain;
a first monitoring capability; and
a second monitoring capability.

Optionally, the capability of processing the first control information includes a number of first control information.

Optionally, if the capability of processing the first control information is related to target control information, and the target control information corresponds to M objects,
one target control information corresponds to A first control information, where A is greater than or equal to 1; or
for each scheduled object, one target control information corresponds to one first control information; or
one target control information corresponds to M first control information.

Optionally, for a first feature, one target control information corresponds to A first control information, where
the first feature includes at least one of the following:
B time units, where B is greater than or equal to 1;
an SCS of a scheduling object;
an SCS of a scheduling object and an SCS of a scheduled object;
a relationship between an SCS of a scheduling object and an SCS of a scheduled object;
a scheduling object; and
a scheduled object.

Optionally, for a second feature, one target control information corresponds to one first control information for each scheduled object; and/or for a second feature, one target control information corresponds to M first control information, where
the second feature includes at least one of the following:
C time units, where C is greater than or equal to 1;
an SCS of a scheduling object;
a relationship between an SCS of a scheduling object and an SCS of a scheduled object;
a scheduling object.

Optionally, in a case that the terminal capability information includes the processing capability of the terminal for the second control information, the terminal capability information further includes at least one of the following:
a processing capability for third control information;
a joint processing capability for the second control information and the first control information; and
a joint processing capability for the second control information and the third control information, where
the third control information corresponds to one object.

Optionally, the processing capability of the terminal for the second control information includes at least one of the following:
a capability of processing second control information within second duration;
a capability of processing second control information related to a second SCS;
a capability of processing second control information related to a second SCS pair;
a capability of processing second control information related to an SCS combination of a scheduled object;
a capability of processing second control information related to a second SCS combination;
a capability of processing second control information related to a quantity of scheduled objects;
a capability of processing second control information related to a total quantity of scheduling object and scheduled object;
a capability of processing second control information related to a relationship between an SCS of a scheduling object and an SCS of a scheduled object;
a capability of processing second control information related to a relationship between SCSs of scheduled objects;
a capability of processing second control information related to a second scheduling object;
a capability of processing second control information related to a second scheduled object;
a capability of processing second control information for TDD;
a capability of processing second control information for FDD;
a capability of processing second control information for a third frequency domain;
a capability of processing second control information for a fourth frequency domain;
a third monitoring capability; and
a fourth monitoring capability.

Optionally, the second SCS includes at least one of the following:
an SCS of a scheduling object;
an SCS of a scheduled object;
a maximum SCS in an SCS of a scheduling object and an SCS of a scheduled object;
a minimum SCS in an SCS of a scheduling object and an SCS of a scheduled object;
a target SCS of a scheduling object;
a target SCS of a scheduled object;
a schedulable SCS;
a first target SCS in schedulable SCSs;
an SCS that can be used for a scheduling object;
a second target SCS in SCSs that can be used for scheduling objects;
an SCS that can be used;
a third target SCS in SCSs that can be used; and
a fourth target SCS in an object group.

Optionally, the relationship between the SCS of the scheduling object and the SCS of the scheduled object includes at least one of the following:
an SCS of a scheduling object is higher than an SCS of a scheduled object;
an SCS of a scheduling object is equal to an SCS of a scheduled object;
an SCS of a scheduling object is lower than an SCS of a scheduled object;
an SCS of a scheduling object is different from an SCS of a scheduled object;
an SCS of a scheduling object is the same as an SCS of a scheduled object; and
a ratio of an SCS of a scheduling object to an SCS of a scheduled object is L.

Optionally, the terminal capability information includes at least one of the following:
terminal capability information corresponding to a scheduling object;
terminal capability information corresponding to an SCS of a scheduling object;
terminal capability information corresponding to an SCS of a scheduled object;
terminal capability information corresponding to a case that an SCS of a scheduling object is higher than an SCS of a scheduled object;
terminal capability information corresponding to a case that an SCS of a scheduling object is equal to an SCS of a scheduled object;
terminal capability information corresponding to a case that an SCS of a scheduling object is lower than an SCS of a scheduled object;
terminal capability information corresponding to a case that a ratio of an SCS of a scheduling object to an SCS of a scheduled object is L;
terminal capability information corresponding to a quantity of supported scheduled objects;
terminal capability information corresponding to a total quantity of scheduling object and supported scheduled object;
terminal capability information corresponding to a band;
terminal capability information corresponding to a band combination;
terminal capability information corresponding to an object combination;
terminal capability information indicated corresponding to a feature set;
terminal capability information corresponding to a half duplex mode;
terminal capability information corresponding to an SCS combination of a scheduling object and a scheduled object; and
terminal capability information corresponding to a frequency range.

In this embodiment of this application, a capability of a terminal to process control information of different objects is defined. The terminal reports information about the terminal capability to a network side device, so that a scheduling constraint of the network side device during scheduling on the terminal meets the terminal capability. This avoids a problem of excessive UE complexity due to too much control information that needs processed by the terminal, and can also avoid a problem that information transmission fails due to discarding or missing detection of the control information, thereby ensuring that the terminal and the network side device have the same understanding of control information that can be actually processed.

An embodiment of this application further provides a communication device. The communication device may be a network side device or a terminal, and includes a processor and a communication interface. The processor is configured to process control information based on a scheduling constraint, where the scheduling constraint includes a scheduling constraint on first control information and/or a scheduling constraint on second control information, where the first control information corresponds to N objects, and N is greater than or equal to 1; and the second control information corresponds to M objects, and M is greater than or equal to 2. This communication device embodiment corresponds to the foregoing scheduling method embodiment. Each implementation process and implementation of the foregoing method embodiment may be applicable to this communication device embodiment, and a same technical effect can be achieved.

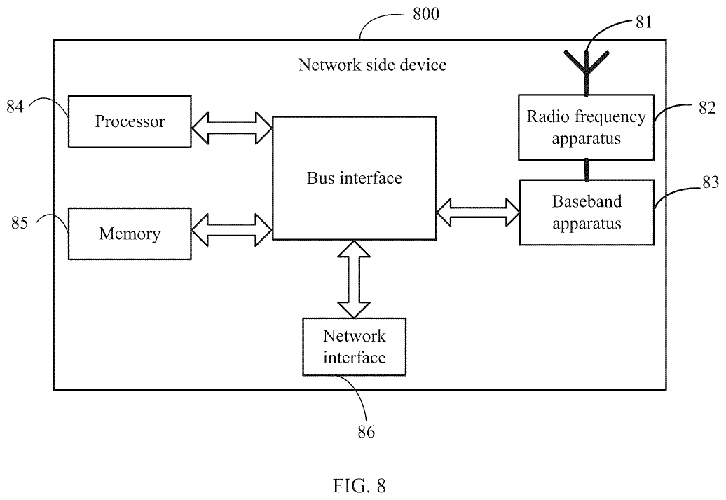

Specifically, an embodiment of this application further provides a communication device. The communication device may be a network side device or a terminal. As shown in FIG. 8, when the communication device is a network side device, the network side device 800 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes information that needs to be sent, and sends the processed information to the radio frequency apparatus 82. The radio frequency apparatus 82 processes the received information, and sends the processed information by using the antenna 81.

In the foregoing embodiment, the method performed by the network side device may be implemented in the baseband apparatus 83. The baseband apparatus 83 includes a baseband processor.

The baseband apparatus 83 may include, for example, at least one baseband board, where a plurality of chips are disposed on the baseband board. As shown in FIG. 8, one chip is, for example, the baseband processor, is connected to the memory 85 through a bus interface, to invoke a program in the memory 85 to perform the operations of the network device shown in the foregoing method embodiment.

The network side device may further include a network interface 86, and the interface is, for example, a common public radio interface (CPRI).

Specifically, the network side device 800 in this embodiment of the present invention further includes an instruction or a program that is stored in the memory 85 and that can be run on the processor 84. The processor 84 invokes the instruction or the program in the memory 85 to perform the method performed by the modules shown in FIG. 5, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing terminal capability indication method or scheduling method embodiment, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing terminal capability indication method or scheduling method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the computer program/program product is executed by at least one processor to implement the processes of the foregoing terminal capability indication method or the scheduling method embodiment, and a same technical effect can be achieved. To avoid repetition, details are not described herein again.

An embodiment of this application further provides a communication system, including a terminal and a network side device. The terminal may be configured to perform the steps of the foregoing terminal capability indication method, and the network side device may be configured to perform the steps of the foregoing scheduling method.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In most circumstances, the former is a preferred implementation manner. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. A terminal capability indication method, comprising:
sending, by a terminal, terminal capability information to a network side device, wherein the terminal capability information comprises a processing capability of the terminal for first control information and/or a processing capability of the terminal for second control information; and
receiving, by the terminal, at least two scheduling information, wherein the at least two scheduling information meet a requirement corresponding to the terminal capability information, and the scheduling information is at least one of the first control information or the second control information, wherein
the first control information corresponds to N objects, and N is greater than or equal to 1; and
the second control information corresponds to M objects, and M is greater than or equal to 2.

2. The method according to claim 1, wherein the processing capability of the terminal for the first control information comprises at least one of the following:
a capability of processing first control information within a first duration;
a capability of processing first control information related to a first subcarrier spacing (SCS);
a capability of processing first control information related to a first SCS pair;
a capability of processing first control information related to a first SCS combination;
a capability of processing first control information related to a quantity of scheduled objects;
a capability of processing first control information related to a total quantity of scheduling object and scheduled object;
a capability of processing first control information related to a relationship between an SCS of a scheduling object and an SCS of a scheduled object;
a capability of processing first control information related to a relationship between SCSs of scheduled objects;
a capability of processing first control information related to a first scheduling object;
a capability of processing first control information related to a first scheduled object;
a capability of processing first control information for time division multiplexing (TDD);
a capability of processing first control information for frequency division multiplexing (FDD);
a capability of processing first control information for a first frequency domain;
a capability of processing first control information for a second frequency domain;
a first monitoring capability; or
a second monitoring capability.

3. The method according to claim 2, wherein the capability of processing the first control information comprises a number of first control information.

4. The method according to claim 3, wherein if the capability of processing the first control information is related to target control information, and the target control information corresponds to M objects,
one target control information corresponds to A first control information, wherein A is greater than or equal to 1; or
for each scheduled object, one target control information corresponds to one first control information; or
one target control information corresponds to M first control information.

5. The method according to claim 4, wherein for a first feature, one target control information corresponds to A first control information, wherein
the first feature comprises at least one of the following:
B time units, wherein B is greater than or equal to 1;
an SCS of a scheduling object;
an SCS of a scheduling object and an SCS of a scheduled object;
a relationship between an SCS of a scheduling object and an SCS of a scheduled object;
a scheduling object; or
a scheduled object;
or,
wherein for a second feature, one target control information corresponds to one first control information for each scheduled object; and/or for a second feature, one target control information corresponds to M first control information, wherein
the second feature comprises at least one of the following:
C time units, wherein C is greater than or equal to 1;
an SCS of a scheduling object;
a relationship between an SCS of a scheduling object and an SCS of a scheduled object; or
a scheduling object.

6. The method according to claim 1, wherein in a case that the terminal capability information comprises the processing capability of the terminal for the second control information, the terminal capability information further comprises at least one of the following:
a processing capability for third control information;
a joint processing capability for the second control information and the first control information; or
a joint processing capability for the second control information and the third control information, wherein
the third control information corresponds to one object.

7. The method according to claim 1, wherein the processing capability of the terminal for the second control information comprises at least one of the following:
a capability of processing second control information within second duration;
a capability of processing second control information related to a second SCS;
a capability of processing second control information related to a second SCS pair;
a capability of processing second control information related to an SCS combination of a scheduled object;
a capability of processing second control information related to a second SCS combination;
a capability of processing second control information related to a quantity of scheduled objects;
a capability of processing second control information related to a total quantity of scheduling object and scheduled object;
a capability of processing second control information related to a relationship between an SCS of a scheduling object and an SCS of a scheduled object;
a capability of processing second control information related to a relationship between SCSs of scheduled objects;
a capability of processing second control information related to a second scheduling object;
a capability of processing second control information related to a second scheduled object;
a capability of processing second control information for TDD;
a capability of processing second control information for FDD;
a capability of processing second control information for a third frequency domain;
a capability of processing second control information for a fourth frequency domain;
a third monitoring capability; or
a fourth monitoring capability;
wherein the second SCS comprises at least one of the following:
an SCS of a scheduling object;
an SCS of a scheduled object;
a maximum SCS in an SCS of a scheduling object and an SCS of a scheduled object;
a minimum SCS in an SCS of a scheduling object and an SCS of a scheduled object;
a target SCS of a scheduling object;
a target SCS of a scheduled object;
a schedulable SCS;
a first target SCS in schedulable SCSs;
an SCS that can be used for a scheduling object;
a second target SCS in SCSs that can be used for scheduling objects;
an SCS that can be used;
a third target SCS in SCSs that can be used; or
a fourth target SCS in an object group.

8. The method according to claim 7, wherein the relationship between the SCS of the scheduling object and the SCS of the scheduled object comprises at least one of the following:
an SCS of a scheduling object is higher than an SCS of a scheduled object;
an SCS of a scheduling object is equal to an SCS of a scheduled object;
an SCS of a scheduling object is lower than an SCS of a scheduled object;
an SCS of a scheduling object is different from an SCS of a scheduled object;
an SCS of a scheduling object is the same as an SCS of a scheduled object; or
a ratio of an SCS of a scheduling object to an SCS of a scheduled object is L.

9. The method according to claim 1, wherein the terminal capability information comprises at least one of the following:
terminal capability information corresponding to a scheduling object;
terminal capability information corresponding to an SCS of a scheduling object;
terminal capability information corresponding to an SCS of a scheduled object;
terminal capability information corresponding to a case that an SCS of a scheduling object is higher than an SCS of a scheduled object;
terminal capability information corresponding to a case that an SCS of a scheduling object is equal to an SCS of a scheduled object;
terminal capability information corresponding to a case that an SCS of a scheduling object is lower than an SCS of a scheduled object;
terminal capability information corresponding to a case that a ratio of an SCS of a scheduling object to an SCS of a scheduled object is L;
terminal capability information corresponding to a quantity of supported scheduled objects;
terminal capability information corresponding to a total quantity of scheduling object and supported scheduled object;
terminal capability information corresponding to a band;
terminal capability information corresponding to a band combination;
terminal capability information corresponding to an object combination;
terminal capability information indicated corresponding to a feature set;
terminal capability information corresponding to a half duplex mode;
terminal capability information corresponding to a frequency range; or
terminal capability information corresponding to an SCS combination of a scheduling object and a scheduled object.

10. A scheduling method, comprising:
processing, by a communication device, control information based on a scheduling constraint, wherein the scheduling constraint comprises a scheduling constraint on first control information and/or a scheduling constraint on second control information, wherein
the first control information corresponds to N objects, and N is greater than or equal to 1; and
the second control information corresponds to M objects, and M is greater than or equal to 2.

11. The method according to claim 10, wherein the method further comprises:
obtaining terminal capability information, wherein the terminal capability information comprises a processing capability of a terminal for the first control information and/or a processing capability of a terminal for the second control information, wherein
the scheduling constraint meets a terminal capability indicated by the terminal capability information.

12. The method according to claim 10, wherein the scheduling constraint on the first control information comprises at least one of the following:
a scheduling constraint on first control information within a first duration;
a scheduling constraint on first control information related to a first SCS;
a scheduling constraint on first control information related to a first SCS pair;
a scheduling constraint on first control information related to a first SCS combination;
a scheduling constraint on first control information related to a quantity of scheduled objects;
a scheduling constraint on second control information related to a total quantity of scheduling object and scheduled object;
a scheduling constraint on first control information related to a relationship between an SCS of a scheduling object and an SCS of a scheduled object;
a scheduling constraint on first control information related to a relationship between SCSs of scheduled objects;
a scheduling constraint on first control information related to a first scheduling object;
a scheduling constraint on first control information related to a first scheduled object;
a scheduling constraint on first control information for time division multiplexing (TDD);
a scheduling constraint on first control information for frequency division multiplexing (FDD);
a scheduling constraint on first control information for a first frequency domain;
a scheduling constraint on first control information for a second band;
a scheduling constraint related to a first monitoring capability; or
a scheduling constraint related to a second monitoring capability.

13. The method according to claim 12, wherein the scheduling constraint on the first control information comprises a number of first control information.

14. The method according to claim 13, wherein if the scheduling constraint on the first control information is related to target control information, and the target control information corresponds to M objects,
one target control information corresponds to A first control information, wherein A is greater than or equal to 1; or
for each scheduled object, one target control information corresponds to one first control information; or
one target control information corresponds to M first control information.

15. The method according to claim 14, wherein for a first feature, one target control information corresponds to A first control information, wherein
the first feature comprises at least one of the following:
B time units, wherein B is greater than or equal to 1;
an SCS of a scheduling object;
an SCS of a scheduling object and an SCS of a scheduled object;
a relationship between an SCS of a scheduling object and an SCS of a scheduled object;
a scheduling object; or
a scheduled object;
or,
wherein for a second feature, one target control information corresponds to one first control information for each scheduled object; and/or for a second feature, one target control information corresponds to M first control information, wherein
the second feature comprises at least one of the following:
C time units, wherein C is greater than or equal to 1;
an SCS of a scheduling object;
a relationship between an SCS of a scheduling object and an SCS of a scheduled object; or
a scheduling object.

16. The method according to claim 10, wherein in a case that the scheduling constraint comprises the scheduling constraint on the second control information, the scheduling constraint further comprises at least one of the following:
a scheduling constraint on third control information;
a joint scheduling constraint on the second control information and the first control information; or
a joint scheduling constraint on the second control information and the third control information, wherein
the second control information corresponds to one object.

17. The method according to claim 10, wherein the scheduling constraint on the second control information comprises at least one of the following:
a scheduling constraint on second control information within second duration;
a scheduling constraint on second control information related to a second SCS;
a scheduling constraint on second control information related to a second SCS pair;
a scheduling constraint on second control information related to an SCS combination of a scheduled object;
a scheduling constraint on second control information related to a second SCS combination;
a scheduling constraint on second control information related to a quantity of scheduled objects;
a scheduling constraint on second control information related to a total quantity of scheduling object and scheduled object;
a scheduling constraint on second control information related to a relationship between an SCS of a scheduling object and an SCS of a scheduled object;
a scheduling constraint on second control information related to a relationship between SCSs of scheduled objects;
a scheduling constraint on second control information related to a second scheduling object;
a scheduling constraint on second control information related to a second scheduled object;
a scheduling constraint on second control information for TDD;
a scheduling constraint on second control information for FDD;
a scheduling constraint on second control information for a third frequency domain;
a scheduling constraint on second control information for a fourth frequency domain;
a scheduling constraint related to a third monitoring capability; or
a scheduling constraint related to a fourth monitoring capability;
wherein the second SCS comprises at least one of the following:
an SCS of a scheduling object;
an SCS of a scheduled object;
a maximum SCS in an SCS of a scheduling object and an SCS of a scheduled object;
a minimum SCS in an SCS of a scheduling object and an SCS of a scheduled object;
a target SCS of a scheduling object;
a target SCS of a scheduled object;
a schedulable SCS;
a first target SCS in schedulable SCSs;
an SCS that can be used for a scheduling object;
a second target SCS in SCSs that can be used for scheduling objects;
an SCS that can be used;
a third target SCS in SCSs that can be used; or
a fourth target SCS in an object group.

18. The method according to claim 10, wherein the scheduling constraint comprises at least one of:
a scheduling constraint for a scheduling object;
a scheduling constraint for an SCS of a scheduling object;
a scheduling constraint for an SCS of a scheduled object;
a scheduling constraint in a case that an SCS of a scheduling object is higher than an SCS of a scheduled object;
a scheduling constraint in a case that an SCS of a scheduling object is equal to an SCS of a scheduled object;
terminal capability information corresponding to a case that an SCS of a scheduling object is lower than an SCS of a scheduled object;
a scheduling constraint in a case that a ratio of an SCS of a scheduling object to an SCS of a scheduled object is L;
a scheduling constraint for a quantity of supported scheduled objects;
a scheduling constraint for a total quantity of scheduling object and supported scheduled object;
a scheduling constraint for a band;
a scheduling constraint for a band combination;
a scheduling constraint for an object combination;
a scheduling constraint for a feature set indication;
a scheduling constraint for a half duplex mode;
a scheduling constraint for an SCS combination of a scheduling object and a scheduled object;
or
a scheduling constraint for a frequency range.

19. A terminal, comprising a processor and a memory, wherein the memory stores a program or an instruction that can be run on the processor, wherein the program or the instruction, when executed by the processor, causes the terminal to perform:
sending terminal capability information to a network side device, wherein the terminal capability information comprises a processing capability of the terminal for first control information and/or a processing capability of the terminal for second control information; and
receiving at least two scheduling information, wherein the at least two scheduling information meet a requirement corresponding to the terminal capability information, and the scheduling information is at least one of the first control information or the second control information, wherein
the first control information corresponds to N objects, and N is greater than or equal to 1; and
the second control information corresponds to M objects, and M is greater than or equal to 2.

20. A communication device, comprising a processor and a memory, wherein the memory stores a program or an instruction that can be run on the processor, and the program or the instruction is executed by the processor to implement the steps of the scheduling method according to claim 10.
